(19) United States
(12) Patent Application Publication
(10) Pub. No.: US 2005/0275343 A1
(43) Pub. Date: Dec. 15, 2005

(54) Organic electroluminescence display apparatus

(76) Inventors: Jun Tanaka, Kawasaki (JP); Shinji Sekiguchi, Kawasaki (JP); Miharu Ootani, Yokohama (JP); Kiyoshi Ogata, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/130,211

(22) Filed: May 17, 2005

(30) Foreign Application Priority Data
May 18, 2004 (JP) 2004-147167

(51) Int. Cl. H05B 33/14; H05B 33/22

(52) U.S. Cl. 313/504; 313/503; 313/506

(57) ABSTRACT

The color filter is a color conversion filter having a color conversion function, wherein white light is emitted from an organic EL to the color filter, transmitted through the color filter, and thereby split into three colors of blue, green and red. At such time, through the absorption of shorter wavelength light that is not usually transmitted through the color filter and through the emission of light having a longer wavelength than that of the absorption region, the transmitted light of the color filter is added to the emitted light to increase brightness. In addition, between the color filter and the transparent substrate, a porous insulation film is formed, wherein the film has a refractive index smaller than that of the transparent substrate, and has that nanopores, so that light-scattering effects can be achieved, and the transmitted light of the color filter is coupled out efficiently to the outside. Use of such a configuration realizes a top-emission structure organic EL display apparatus in which a white color emission organic EL is combined with color filter to achieve full color display, wherein white light emitted from the organic EL is converted and split by the color filter and thereby coupled out efficiently to the outside.

### INCORPORATION BY REFERENCE

The present application claims priority from Japanese application JP 2004-147167 filed on May 18, 2004, the content of which is hereby incorporated by reference into this application.

### BACKGROUND OF THE INVENTION

The present invention relates to an organic electroluminescence display apparatus, and in particular, to a display apparatus which achieves color display by splitting into three primary colors light which have been emitted from an organic electroluminescence layer and transmitted through a color conversion filter formed on an opposing transparent substrate, the high performance organic electroluminescence display apparatus having improved coupling-out efficiency of emission from the transparent substrate.

Unlike liquid-crystal display apparatuses which require a backlight, organic electroluminescence (hereinafter referred to as “organic EL”) display apparatuses, are self-luminescent. Since organic ELs are thinner than liquid crystals, and have a wide view angle and a fast response speed, they are excellent in moving-image display. In recent years, research and development has been active, with frequent announcements of product commercialization.

The basic structure of an organic EL display apparatus is a sandwich structure, wherein an organic EL emission layer is sandwiched between two electrodes. In such a case, it is necessary that the electrode on the side which couples-out the emission layer light to the outside is transparent. Indium tin oxide materials and indium zinc oxide materials, which are also used in liquid-crystal display apparatuses, are known as transparent electrodes.

Organic EL display apparatuses can be broadly classified into two structures, depending on the coupling-out direction of their emission. Organic EL display apparatuses having a structure which couples-out the emission layer light to the outside via a transparent substrate formed by the organic EL emission layer are called “bottom emission” type, while those having a structure which couples-out the emission layer light to the outside via a transparent substrate opposing the substrate formed by the organic EL emission layer are called “top emission” type.

For an active-matrix organic EL display apparatus formed with a thin film transistor (hereinafter referred to as a “TFT”) on a substrate formed by the organic EL emission layer, a bottom emission type which couples-out the emission layer light to the outside via a transparent substrate formed with the TFT circuit suffers from the problem that brightness deteriorates due to the transmitted light being shielded by the wiring pattern of the circuit.

In contrast, an organic EL display apparatus having a top emission structure is a preferable structure as the organic EL layer emissions can be effectively employed, since the shielding problem caused by the circuit substrate does not exist.

However, whichever mode is employed, glass is often used for the transparent substrate. In such a case, under classical optics theory, from the total reflection angle of the glass and air, it is said that approximately 80% of the light generated at the organic EL emission layer is trapped within the substrate, whereby only approximately 20% is coupled-out to the air (see, for example, M. H. Lu, Appl. Phys. Lett., Vol. 78, p 1927 (2001)). Therefore, even if brightness is increased by increasing the emission efficiency of the organic EL layer, or even if emissions are used more effectively as a top emission type, the light coupling-out efficiency to the outside of the transparent substrate becomes an issue, whereby the problem exists that display performance cannot be increased.

As a means to resolve such a problem, as disclosed in JP-A-2003-257622, a technique has been proposed wherein the coupling-out efficiency can be increased by the use of a transparent electrode substrate having a low refractive index consisting of a silica aerogel, which has a lower refractive index than that of a glass substrate. A technique has also been proposed wherein the coupling-out efficiency can be increased by forming a film consisting of a spin-on glass material having pores in the film, which has a lower refractive index than that of a glass substrate (see T. Nakayama, et al., International Display Workshops 2002 (IDW '02) proceedings, p 1163 (2002)).

T. Nakayama et al. also disclose in the proceedings that a low refractive index layer can be provided. It is stated in the proceedings that it is preferable for the density of especially the low refractive index layer to be 0.4 g/cm³ or less.

As organic EL emission materials, small molecular materials and polymer materials are known. When forming an organic EL emission layer pattern using a small molecular material, an evaporation method is commonly employed in which the material is heated and a desired pattern is formed via a mask or the like. For organic EL emission layer patterns using a polymer material, it is known to use methods for formation which employ an ink-jet method, a printing method or the like.

For organic EL display apparatuses, systems for achieving full color display are broadly classified into the following three systems: system (1), system (2) and system (3).

(1) Systems which employ an organic EL material having an emission spectrum in the three primary color regions of red, green and blue. These systems, particularly when applied to an active-matrix organic EL display apparatus, require the organic EL material to be formed onto the matrix pixels. In order to increase the definition of the pixels using a pattern formation method such as that described above, problems exist with increasing the definition of the metal mask used for deposition, increasing the precision of the inkjet and the like, whereby producing a large-screen high-definition display apparatus becomes extremely difficult.

(2) Full-color display systems which combine a white color EL material having an emission spectrum in the visible light region and a trichromatic color filter of red, green and blue, in which the white color emission is transmitted through the color filter layer for conversion into the three primary colors of red, green and blue (see JP-A-2003-257622).

This principle is the same full color display technology as that of combining the liquid-crystal display backlight white color light and a color filter substrate. It is acceptable in such a system to form the white color EL layer over the entire surface of the substrate, whereby since there is no need to form a pattern, there are none of the above-described problems even when increasing the definition of the pixels.

(3) Full-color display systems which combine an EL material having an emission spectrum in the near ultraviolet and blue color region and a color conversion filter of a fluorescent material having an emission spectrum in the red, green and blue color regions which absorbs light emitted from the EL material, for conversion into the three primary colors of red, green and blue (see JP-A-3-152897).

It is acceptable in such a system to form the near ultraviolet and blue EL layer over the entire surface of the substrate, and there is no need to form a pattern. In addition, similar to the combination of a white color EL and a trichromatic color filter, there is no problem with the light amount attenuating to ⅓ as a result of the color filter.

### SUMMARY OF THE INVENTION

Applying the technology disclosed in JP-A-2003-257622 to an active-matrix organic EL display apparatus having a top emission structure in particular, suffers from the following problem. That is, the three primary colors of blue, green and red are displayed by transmitting a white emission through a color filter layer for selectively transmitting only light in a specific wavelength region.

For example, since for a blue filter only blue light is transmitted from among the white light, at least ⅔ of the incident light is unavoidably lost (same for the green or red filters), giving rise to the problem that the transmitted light attenuates to ⅓, whereby performance in terms of display brightness is dependent on the emission brightness of the white color EL material.

Applying the technology disclosed in JP-A-3-152897 to an active-matrix organic EL display apparatus having a top emission structure in particular, suffers from the problem that performance in terms of display brightness is dependent on the emission brightness of the near-ultraviolet and blue color EL material. However, a high-brightness ultraviolet and blue color EL material is yet to be achieved with the current and voltage values that can be driven using a conventional TFT circuit.

Furthermore, unlike the combination of a white color EL and a color filter, a full color display absorbs near-ultraviolet and blue color emissions, which requires that an emissive material be used that has an emission spectrum in the green and red color regions. However, the red color and green color emissive materials which for achieving high-efficiency light absorption and emission become a problem.

In addition, regarding the light coupling-out from the transparent substrate formed by the color filter layer or the color conversion layer, no matter which system is used a substantial part of the light generated at the organic EL emission layer is trapped within the transparent substrate, wherein the coupling-out efficiency to the air is low. Even if brightness is improved by improving the emission efficiency of the organic EL layer, the light coupling-out efficiency to the outside of the transparent substrate becomes a problem, whereby the problem exists that display performance cannot be improved.

It is an object of the present invention to resolve the various problems with the background art described above, by providing a high-brightness active-matrix organic EL display apparatus having a top emission structure which achieves full color display through the combination of a white color emission EL material and a color filter substrate, which can efficiently couple-out emissions from the organic EL layer towards the color filter substrate side.

In a top emission structure active-matrix organic EL display apparatus which achieves full color display by combining a white color emission EL material and a color filter substrate, the color filter substrate comprises on a transparent substrate thereof a silicon oxide (SiO)-containing porous insulation film for efficiently coupling-out light. On that upper layer is provided a color filter layer of a pigment dispersion system for blue, green and red colors, wherein the green and red filter layers are additionally color conversion filters having a color conversion function. White color emissions of the EL material are injected from the color filter layer surface, transmitted through the color filter substrate, whereby the light is split up into the three colors of blue, green and red.

Usually, for the combination of a white color emission EL material and a blue, green and red filter of a pigment dispersion system, when the white color emission is transmitted through the respective color filters, ⅔ or more of the incident light is unavoidably lost.

However, by using the color conversion filter having a pigment conversion function according to the present invention, in the green filter layer, by absorbing shorter wavelength light that is not usually transmitted and emitting light in the green color region, the transmitted light of the green filter layer is augmented with the emitted component, to thereby increase brightness. In the red filter layer, by absorbing shorter wavelength light that is not usually transmitted and emitting light in the red color region, the transmitted light of the red filter layer is augmented with the emitted component, to thereby increase brightness.

The above-described color conversion filter possesses the following characteristics (1) through (6).

(1) The color conversion filter is formed comprising a substance for emitting light in a visible light region in the pigment dispersion color filter.

(2) The color conversion filter is formed from two layers, a pigment dispersion color filter layer and a color conversion filter layer which comprises a substance for emitting light in a visible light region.

(3) In the color conversion filter, the green filter is formed by dispersing a green color pigment therein, and comprises a substance for absorbing light having a wavelength of 460 nm or less and emitting light having a wavelength of 460 nm or more. The green filter is formed from two layers, a pigment dispersion green filter layer and a green conversion filter layer which comprises a substance for absorbing light having a wavelength of 460 nm or less and emitting light having a wavelength of 460 nm or more.

(4) In the color conversion filter, the red filter is formed by dispersing a red color pigment therein, and comprises a substance for absorbing light having a wavelength of 550 nm or less and emitting light having a wavelength of 550 nm or more. The red filter is formed from two layers, a pigment dispersion red filter layer and a red conversion filter layer which comprises a substance for absorbing light having a wavelength of 550 nm or less and emitting light having a wavelength of 550 nm or more.

(5) In the color conversion filter, the blue filter is formed from two layers, a pigment dispersion blue filter layer and a blue conversion filter layer which comprises a substance for absorbing light having a wavelength of 420 nm or less and emitting light having a wavelength of 420 nm or more.

(6) The color conversion filter comprises a blue filter comprising a pigment dispersion blue filter layer; a green conversion filter which consists of two layers, a pigment dispersion green filter layer and a color conversion filter layer which comprises a substance for absorbing light having a wavelength of 460 nm or less and emitting light having a wavelength of 460 nm or more; a red conversion filter which consists of two layers, a pigment dispersion red filter layer and a color conversion filter layer which comprises a substance for absorbing light having a wavelength of 550 nm or less and emitting light having a wavelength of 550 nm or more; and a color conversion layer covering the entire surface of these filter layers, which comprises a substance for absorbing light having a wavelength of 420 nm or less and emitting light having a wavelength of 420 nm or more.

Various kinds of fluorescent materials are commonly known as substances which absorb light and emit light having a longer wavelength. While these substances can be employed, preferable fluorescent materials to be used in the present invention are illustrated in FIG. 13. The present invention is, however, not to be limited to these fluorescent materials.

The fluorescent material can be employed dispersed by dissolving in the photosensitive material solution used for pigment dispersion color filter layer formation. From this, a color conversion filter comprising a pigment and a light-emitting substance is formed.

The fluorescent material can also be employed dispersed by dissolving in a photosensitive acrylic polymer material or the like having an acrylic crosslinking functional group and a high light transmittance in the visible light region. From this, a film comprising a light-emitting substance can be formed, in which a color conversion filter layer having a 2-layer structure with the pigment dispersion filter layers is formed. Well-known photolithography techniques can be employed as the formation method for the color filter layer. Various kinds of printing methods can also be employed.

The above-described porous insulation film is an insulation film which possesses the following characteristics (1) through (7).

(1) Film Density

The film density is 0.6 g/cm³ to less than 1.8 g/cm³, and is more preferably in a range of 0.6 g/cm³ to 1.5 g/cm³ or less. If the film density is less than 0.6 g/cm³, associated physical properties, especially film hardness and degree of elasticity, decrease, whereby it is difficult to say that such an insulation film is suitable for practical use in an active-matrix organic EL display apparatus.

If the film density is 1.8 g/cm³ or more, the insulation film structure as a consequence has few pores, whereby a porous insulation film suitable for achieving a high-brightness active-matrix organic EL display apparatus that is capable of efficiently coupling-out emissions, which is an object of the present invention, cannot be obtained.

(2) Film Refractive Index

The film refractive index is in the range of 1.1 to 1.4. If the refractive index is less than 1.1, the associated film density decreases, or in other words, the film characteristics such as film hardness and degree of elasticity decrease, whereby it would be hard to say that such an insulation film is suitable for practical use in an active-matrix organic EL display apparatus.

Further, if the refractive index exceeds 1.4, the difference between the refractive index of the transparent substrate used in the organic EL display apparatus and that of the transparent electrode decreases, the efficiency of coupling-out light emitted from the organic EL layer to the outside is poor, whereby a high-brightness active-matrix organic EL display apparatus, which is an object of the present invention, cannot be achieved.

(3) Pore Diameter of the Main Pore Constituents in the Film:

The pore diameter of the main pore constituents in the porous insulation film according to the present invention is in the range of 0.2 nm to 5.0 nm, and more preferably in the range of 0.2 nm to 3.0 nm. The porous insulation film according to the present invention is a porous film which exhibits a pore diameter distribution characteristic as illustrated in FIG. 12 as one example. Main pore constituents as mentioned here refer to constituents which have a pore diameter up to 1/10th of the pore diameter of a pore constituent having a maximum pore diameter.

If the pore diameter of the main constituents is less than 0.2 nm, their pore diameter is too small, thereby weakening the light scattering effects caused by the pores, so that the efficiency of the light for coupling-out the emissions from the organic EL layer to the outside is poor, whereby a high-brightness active-matrix organic EL display apparatus, which is an object of the present invention, cannot be achieved.

If the pore diameter of the main components greatly exceeds 5.0 nm, film density which is associated therewith decreases, in other words, the film characteristics such as film hardness and degree of elasticity decrease, whereby it would be hard to say that such an insulation film is suitable for practical use in an active-matrix organic EL display apparatus.

(4) Average pore diameter in the film:

The average pore diameter in the porous insulation film according to the present invention is in the range of 0.6 nm to 3.0 nm. If the average pore diameter is less than 0.6 nm, the pore diameters are too small, thereby weakening the light scattering effects caused by the pores, so that the efficiency of the light for coupling-out the emissions from the organic EL layer to the outside is poor, whereby a high-brightness active-matrix organic EL display apparatus, which is an object of the present invention, cannot be achieved.

If the average pore diameter greatly exceeds 3.0 nm, film density which is associated therewith decreases, in other words, the film characteristics such as film hardness and degree of elasticity decrease, whereby it would be hard to say that such an insulation film is suitable for practical use in an active-matrix organic EL display apparatus.

(5) Maximum Pore Diameter in the Film:

The maximum pore diameter in the porous insulation film according to the present invention is in the range of 0.4 nm or more to no greater than 2.0 nm. If the maximum pore diameter is less than 0.4 nm, the pore diameters are too small, thereby weakening the light scattering effects caused by the pores, so that the efficiency of the light for coupling-out the emissions from the organic EL layer to the outside is poor, whereby a high-brightness active-matrix organic EL display apparatus, which is an object of the present invention, cannot be achieved.

If the maximum pore diameter exceeds 2.0 nm, film density which is associated therewith decreases, in other words, the film characteristics such as film hardness and degree of elasticity decrease, whereby it would be hard to say that such an insulation film is suitable for practical use in an active-matrix organic EL display apparatus.

(6) Film Transmittance:

The porous insulation film according to the present invention has a transmittance in the visible wavelength region of 80% or more, and more preferably 90% or more. If the transmittance is less than 80%, the shielding effect prevails over the light coupling-out effect, whereby an active-matrix organic EL display apparatus, which is an object of the present invention, cannot be achieved.

(7) Moisture Absorption Characteristic

The porous insulation film according to the present invention comprises open nanopores which in some cases possess adsorb moisture.

The porous insulation film according to the present invention can be obtained by heating a coating film which has as a main constituent a hydrogen silsesquioxane compound or a methyl silsesquioxane compound.

A coating solution which has as a main constituent a hydrogen silsesquioxane compound or a methyl silsesquioxane compound is coated onto a substrate. This coated substrate is subjected to intermediate heating between 100° C. or more to less than 300° C., and then heated in a nitrogen atmosphere or similar inert atmosphere under conditions of between 300° C. or more to 400° C. or less, whereby the Si—O—Si bonds are formed into a ladder structure, to thereby ultimately yield an insulation film having SiO as a main constituent.

In the insulation film having SiO as a main constituent obtained by heating a coating film having as a main constituent a hydrogen silsesquioxane compound or a methyl silsesquioxane compound, pore formation can be controlled and pore diameter range can be held within a selective range by incorporating an easily decomposable component, other than methyl isobutyl ketone or the like, into a silsesquioxane compound solution at a temperature less than the final heating conditions, i.e. less than 300° C., to thereby change the decomposition behavior according to the deposition temperature, whereby the decomposed remains of this constituent in the film are formed as pores.

If the diameter of the nanopores is large, a problem newly arises that the mechanical strength as a structural body of the insulation film itself decreases, so that it is necessary to pay careful attention to the size of the pores incorporated into the insulation film. In view of this, the present invention suppresses the decrease in mechanical strength of the insulation film by controlling the range of the pore diameters.

Methods for coating the solution include a spin-coating method, a slit-coating method or a printing method. Since the coating film is formed by heating, when fine wires are formed in high density such methods are superior to CVD films in terms of better coatability of uneven portions and in that surface unevenness can be removed.

The porous insulation film according to the present invention can also be formed using a CVD method (Chemical Vapor Deposition) which employs a gas having as a main constituent an alkylsilane compound or an alkoxysilane compound. This film is an insulation film obtained by forming a film under a chemical vapor deposition reaction employing a gas having as a main constituent an alkylsilane compound or alkoxysilane compound, then heating this formed film between 300° C. or more to 450° C. or less.

When forming an insulation film by a CVD method, a source gas having an alkylsilane compound or an alkoxysilane compound as a main constituent is used to ultimately form an insulation film having SiO as a main constituent by ECR (Electron Cyclotron Resonance), plasma CVD method or similar method. In such a case, a technique to control the diameter of the pores present in the insulation film is, for example, to incorporate a constituent which has a high thermal decomposition temperature as a source gas, and heat at between 350° C. to 450° C. during deposition, to thereby form as pores the decomposed remains of such constituent in the film.

Using such a technique makes it possible to change the decomposition behavior according to the deposition temperature by selecting a variety of constituents having a high thermal decomposition temperature, which in turn allows the pore diameters to be controlled and the pore diameter range to be held within a selective range.

If the diameter of the nanopores is large, problems newly arise such as the mechanical strength as a structural body of the insulation film itself decreasing, or the leak current flowing in the insulation film increasing to thereby reduce the dielectric strength voltage which is a characteristic of the insulation film. It is therefore necessary to pay careful attention to the size of the pores incorporated into the insulation film.

In view of this, the present invention suppresses the decrease in mechanical strength and dielectric strength voltage of the insulation film by controlling the range of the pore diameters.

By means of the above-described color conversion filter, in the green filter layer, shorter wavelength light that is not usually transmitted is absorbed and light in the green color region is emitted, whereby the transmitted light of the green filter layer is augmented with the emitted component, to thereby increase brightness. In the same manner, in the red filter layer, shorter wavelength light that is not usually transmitted is absorbed and light in the red color region is emitted, whereby the transmitted light of the red filter layer is augmented with the emitted component, to thereby increase brightness. In the same manner, in the blue filter layer, shorter wavelength light that is not usually transmitted is absorbed and light in the blue color region is emitted, whereby the transmitted light of the blue filter layer is augmented with the emitted component, to thereby increase brightness.

In addition, by comprising on the filter layer a color conversion filter which absorbs light having a wavelength of 420 nm or less and which generates light having a wavelength of 420 nm or more, brightness can be increased by, in the green filter layer, absorbing light having a wavelength of 420 nm or more and emitting light in the green color region, whereby the transmitted light of the green filter layer is augmented with the emitted component, and in the red filter layer, absorbing light having a wavelength of 420 nm or more and emitting light in the red color region, whereby the transmitted light of the red filter layer is augmented with the emitted component.

Organic EL display apparatuses display using the self-emitted light of an EL material. Such an emission is itself non-polarized light. Therefore, an organic EL display apparatus is not a display in which the shutter effect of a liquid-crystal material is applied by using polarized light in the manner of a liquid crystal display apparatus. Since the emission which is augmented using the above-described color conversion filter is also non-polarized light, such non-polarized light emission can be completely augmented, to thereby effectively achieve an improvement in brightness.

A porous insulation film which possesses the above-described characteristics (1) through (6) has a smaller refractive index than a transparent substrate serving as a conversion filter substrate, and by incorporating the light-scattering effects resulting from the nanopores that are present in the film, can reduce the trapping of emissions, including the emissions from the organic EL layer transmitted through the conversion filter and the emissions converted by the conversion filter of the emissions of the organic EL layer, within the transparent substrate for efficient coupling-out to the outside of the transparent substrate, to thereby improve brightness.

According to a porous insulation film which possesses the above-described characteristic (7), a substrate, which comprises a light-emitting device with an organic EL layer formed between electrode layers, and a transparent substrate, which comprises a color conversion filter on a surface opposing the above-described light-emitting device substrate are stacked, and the substrate periphery is sealed, wherein an organic EL display apparatus possesses a drying efficiency that adsorbs moisture present between the sealed substrates.

It is known that the emission life of an organic EL display apparatus degrades due to moisture. However, a moisture adsorbing function allows for a desiccant, which would be required in a conventionally sealed organic EL display apparatus, to be left out, whereby material costs and the step for adding the desiccant can be curtailed.

Other objects, features and advantages of the invention will become apparent from the following description of the embodiments of the invention taken in conjunction with the accompanying drawings.

### BRIEF DESCRIPTION OF THE DRAWINGS

FIG. 1 is a cross-sectional view for explaining the active-matrix organic EL display apparatus which is a first Example according to the present invention;

FIG. 2 is a cross-sectional view for explaining the active-matrix organic EL display apparatus which is a second Example according to the present invention;

FIG. 3 is a cross-sectional view for explaining the active-matrix organic EL display apparatus which is a third Example according to the present invention;

FIG. 4 is a cross-sectional view for explaining the active-matrix organic EL display apparatus which is a fourth Example according to the present invention;

FIG. 5 is a cross-sectional view for explaining the active-matrix organic EL display apparatus which is a fifth Example according to the present invention;

FIG. 6 is a cross-sectional view for explaining the active-matrix organic EL display apparatus which is a sixth Example according to the present invention;

FIG. 7 is a cross-sectional view for explaining a sealed configuration of an active-matrix organic EL display apparatus according to the present invention;

FIG. 8 is a bird's eye view for explaining an active-matrix organic EL display apparatus according to the present invention;

FIG. 9 is an emission spectral intensity comparison graph of the visible light wavelength regions measured for the organic EL display apparatuses of Example 1 and Comparative Example 1;

FIG. 10 is a diameter distribution graph of the open nanopores in the porous insulation film surface according to the present invention;

FIG. 11 is a graph which explains the water vapor adsorption characteristic of the porous insulation film surface according to the present invention;

FIG. 12 is a graph which expresses the diameter distribution of the nanopores present in the porous insulation film surface according to the present invention; and

FIG. 13 is an explanatory chart which illustrates preferable emission substances used by the present invention.

### DETAILED DESCRIPTION OF THE PREFERRED EMBODIMENTS

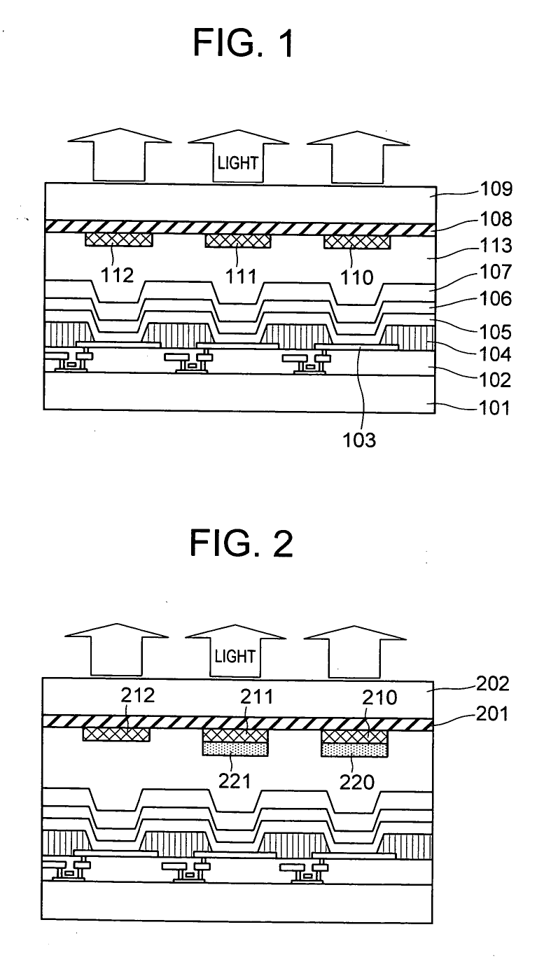

Embodiments of the present will now be described using FIGS. 1 to 6.

### EXAMPLE 1

As one example of the organic EL display apparatus according to the present invention, an active-matrix organic EL display apparatus will be explained using the cross-sectional view illustrated in FIG. 1.

A thin-film transistor (TFT) element circuit layer 102 formed with a thin-film transistor and electrode wiring was formed on a non-alkali glass substrate 101. Electrodes 103 sandwiching an organic EL layer 105 were separated by pixel units of an active-matrix organic EL display apparatus by a separating insulation film 104. The white color organic EL layer 105 was formed over the entire surface of the electrodes 103 and the separating insulation film 104, and a transparent electrode 106 was formed over that entire surface. Above this, an inorganic insulation film 107 was coated having gas barrier properties so that moisture or oxygen was not transmitted therethrough.

The TFT element circuit layer 102 was formed from a TFT employing amorphous silicon or low-temperature polycrystalline polysilicon, a gate, a source, a drain electrode layer, an insulation layer and the like.

The organic EL layer 105 was formed from a white color emission organic EL material. The formation method can employ a dry deposition method such as evaporation, or a wet-type printing method such as screen printing or an ink-jet method.

The white color organic EL layer 105 was formed from a continuous deposition of a hole transport layer constituted by a small molecule organic EL material, a hole block layer, an emission layer and electron transport layer, and an electron injection layer. Further, the organic EL material, whose emission color was in a complementary color relationship to the hole transport layer, was formed from a continuous deposition of the emission layer and electron transport layer constituted in a stacked manner.

The hole transport material forming the hole transport layer and the electron transport material forming the emission layer and electron transport layer are not restricted, and may be selected from a variety of materials such as those illustrated below. Techniques can also be used such as separating the electron transport layer and emission layer from each other and having them composed of different materials, or allowing a dopant to co-exist in the emission layer in order to adjust emission intensity and color tone.

Examples of the hole transport material include aromatic mono-, di-, tri- and tetra-polyamine compounds and derivatives and polymerization compounds thereof; and hydrazone, silanamine, enamine, quinacridone, phosphamine, phenanthridine, benzylphenyl and styryl compounds. Derivatives of such compounds can also be used, as can polymers, e.g., polyvinylcarbazole, polycarbonate, polysilane, polyamide, polyaniline, polyphosphazene and aromatic amine-containing polymethacrylate.

Examples of the electron transport material include 8-hydroxyquinoline aluminum complexes and derivatives thereof, represented by tris(8-quinolinol)-aluminum complexes or derivates; derivatives of cyclopentadiene, perynone, oxadiazole, bisstilben, distilpyrazine, pyridine, naphthyridine and triazine etc.; nitrile compounds and p-phenylene compounds; rare-earth elements; and metal complexes.

As the hole block material, a triazole compound or derivative thereof and the like can be used.

As the organic EL material for white color emission, a wide variety of laminates or material combinations can be used. In order to attain the effects of the present invention, the invention is not limited to the above-described materials.

In the present example, by using an aluminum electrode or chromium electrode as the electrode 103 and an ITO electrode or an IZO electrode as the transparent electrode 106, white color organic EL layer 105 emissions, including the reflection from the electrode 103 side, were transmitted through the transparent electrode 106 and the gas barrier film 107 and led to the opposing transparent substrate 109 side via a sealed space 113.

Red, green and blue filter patterns (110, 111, 112) were formed on the opposing transparent substrate 109 to split the light from the organic EL layer 105 to achieve full color display. Between the patterns and the opposing transparent substrate 109 was formed a porous insulation layer 108.

It is sufficient for this opposing transparent substrate 109 to be a transparent substrate which possesses the resistance to withstand the forming temperature of the below-described color filter, wherein, in the same manner as the TFT circuit substrate, a non-alkali glass substrate or a transparent resin substrate can be used therefor.

The porous insulation film 108 was a silicon oxide (SiO)-containing film in which nanopores were present in the film, having the characteristic that its density was from 0.6 g/cm³ or more to less than 1.8 g/cm³, and its film refractive index was lower than that of the non-alkali glass substrate 101. Furthermore, the porous insulation film possessed the above-described characteristics (2) through (6). A porous insulation film possessing these characteristics has good physical properties.

A production process for such a porous insulation layer 108 will now be described.

The porous insulation layer 108 is a porous substance which has nanopores in its film, contains SiO and has the characteristic that its density is from 0.6 g/cm³ or more to less than 1.8 g/cm³, which can be obtained by heating a coating solution having as a main constituent a hydrogen silsesquioxane compound or a methyl silsesquioxane compound.

Such an insulation film can be prepared by coating onto a substrate a coating solution which has as a main constituent a hydrogen silsesquioxane compound or a methyl silsesquioxane compound, subjecting the coated substrate to intermediate heating between 100° C. or more to less than 300° C., and then heating in a nitrogen atmosphere or similar inert atmosphere under conditions of between 300° C. to 450° C., whereby the Si—O—Si bonds are formed into a ladder structure, to thereby ultimately yield an insulation film having SiO as a main constituent.

In the above-described coating film having SiO as a main constituent, which was obtained by heating a coating solution having as a main constituent a hydrogen silsesquioxane compound or a methyl silsesquioxane compound, pore formation can be controlled and the pore diameter range can be held within the selective range disclosed by the above-described characteristics (3) through (5) by incorporating into a silsesquioxane compound solution an easily decomposable component, other than methyl isobutyl ketone or the like, at a temperature less than the final heating conditions, i.e. less than 300° C., to thereby change the decomposition behavior according to the deposition temperature, whereby the decomposed remains of this constituent in the film are formed as pores.

In such as case, if the diameter of the nanopores is large, a problem newly arises that the mechanical strength as a structural body of the insulation film itself decreases, so that it is necessary to pay careful attention to the size of the pores incorporated into the insulation film. In view of this, the present invention suppresses the decrease in mechanical strength of the insulation film by controlling the range of the pore diameters to conform with the above-described characteristics (3) through (5).

Methods for applying the solution include a spin-coating method, a slit-coating method or a printing method. Since the coating film is formed by heating, when fine wires are formed in high density, it is possible to drastically reduce plant costs, whereby these methods are superior to CVD films in terms of production line investment costs as well as suppression of device costs.

Another method for producing the porous insulation film is to form a porous insulation film, which is a porous substance having nanopores in its film, comprises SiO and which has the characteristic that its density is from 0.6 g/cm³ or more to less than 1.8 g/cm³, using a CVD method which employs a source gas having as a main constituent an alkylsilane compound or an alkoxysilane compound. Preferable examples of alkylsilane compounds as mentioned here include trimethylsilane, triethylsilane, tetramethylsilane, tetraethylsilane and the like. Preferable examples of alkoxysilane compounds as used here include trimethoxysilane, triethoxysilane, tetramethoxysilane, tetraethoxysilane and the like.

Such an insulation film can be obtained by forming a film by CVD using a gas which has as a main constituent an alkylsilane compound or an alkoxysilane compound, then heating under conditions of between 300° C. or more to less than 450° C.

When forming an insulation film by a CVD method, a source gas having an alkylsilane compound or an alkoxysilane compound as a main constituent is used to ultimately form an insulation film having SiO as a main constituent by ECR (Electron Cyclotron Resonance), plasma CVD method or similar method.

In such a case, a technique to control the diameter of the pores present in the insulation film is, for example, to incorporate a constituent which has a high thermal decomposition temperature as a source gas, and heat at between 350° C. to 450° C. during deposition, to thereby form as pores the decomposed remains of such constituent in the film. Using such a technique enables the pore diameter range to be held within a selective range by selecting a variety of constituents having a high thermal decomposition temperature, whereby it is possible to change the decomposition behavior according to the deposition temperature, which in turn allows the pore diameters to be controlled.

In such a case as well, if the diameter of the nanopores is large, a problem newly arises that the mechanical strength as a structural body of the insulation film itself decreases, so that it is necessary to pay careful attention to the size of the pores incorporated into the insulation film. In view of this, the present invention suppresses the decrease in mechanical strength of the insulation film by controlling the range of the pore diameters so as to be in accordance with the above-described characteristics (3) to (5).

Next, the red, green and blue filter patterns (110, 111, 112) of the opposing transparent substrate 109 side will be explained.

The red filter layer 110 was formed into a desired pattern using a well-known photolithography technique employing a solution which mixed a substance that absorbed light having a wavelength of 550 nm or less and emitted light having a wavelength of 550 nm or more in a pigment dispersion resist solution in which a red color pigment was dispersed.

The green filter layer 111 was formed into a desired pattern using a well-known photolithography technique employing a solution which mixed a substance that absorbed light having a wavelength of 460 nm or less and emitted light having a wavelength of 460 nm or more in a pigment dispersion resist solution in which a green color pigment was dispersed.

The blue filter layer 112 was formed into a desired pattern using a well-known photolithography technique employing a pigment dispersion resist solution in which a blue color pigment was dispersed.

These patterns can be formed by coating the above-described solution onto the porous insulation film 108 of the glass substrate 109 and preheating using a hot plate system, to thereby form a coating film. Next, using a well-known photolithography technique, the coating film is exposed and developed to form a desired pattern. Subsequently, after using a hot plate system, the obtained desired pattern is heated and cured. This pattern formation method is carried out for the red, green and blue filter patterns. While in the present example explanation was made of a photolithography technique, various kinds of printing methods can also be used.

In the present example the red and green filters (110, 111) were color conversion filters comprising a light-emitting substance. White color organic EL 105 emissions were split by transmitting through the red, green and blue filters (110, 111, 112), whereby light was emitted in the 3 primary colors required for full color display.

In such a case, in the red conversion filter layer 110, shorter wavelength light that is not usually transmitted was absorbed and light in the red color region was emitted, whereby the transmitted light of the red conversion filter layer 110 was augmented with the emitted component, to thereby increase brightness. In addition, in the green conversion filter layer 111, shorter wavelength light that is not usually transmitted was absorbed and light in the green color region was emitted, whereby the transmitted light of the green conversion filter layer 111 was augmented with the emitted component, to thereby increase brightness.

Furthermore, a porous insulation film 108 which possessed the above-described characteristics (1) through (6) allowed brightness to be increased due to the facts that its refractive index was smaller than that of the opposing transparent substrate 109 and the light-scattering effects resulting from the nanopores that were present in the film were augmented, whereby the trapping of emissions, including the emissions from the organic EL layer 105 transmitted through the red, green and blue filters (110, 111, 112) and the emissions converted by the color conversion filters (111, 112) of the emissions from the organic EL layer 105, within the transparent substrate 109 was reduced for efficient coupling-out to the transparent substrate exterior.

Ultimately, the organic EL display apparatus is completed by connecting to a peripheral circuit mounted with a driver LSI for driving a thin-film transistor or an LSI for control, power supply or the like.

### EXAMPLE 2

Next, as one example of the organic EL display apparatus according to the present invention, an organic EL display apparatus provided with a color conversion filter will be explained using the substrate cross-sectional view illustrated in FIG. 2.

Since the difference between FIG. 2 and Example 1 as illustrated in FIG. 1 lies in the structure of the opposing transparent substrate 202, this point will now be explained.

To achieve full color display by splitting the emissions from the white color organic EL layer, an opposing transparent substrate 202 was formed with red, green and blue filter patterns (210, 211, 212), and red and green conversion filter patterns (220, 221). Between these filter patterns and the opposing transparent substrate 202 was formed a porous insulation film 201.

In this case the porous insulation film 201 was an insulation film which contained SiO and possessed the above-described characteristics (1) through (6). An insulation film which possesses these characteristics has good physical properties. The production method for this porous insulation film was the same as the production process explained for Example 1.

Next, the opposing transparent substrate 202-side red, green and blue pigment dispersion color filters (210, 211, 212), and the red and green conversion filters (220, 221) will be explained.

The red filter layer 210 was formed into a desired pattern using a well-known photolithography technique employing a pigment dispersion resist solution in which was dispersed a red pigment. The green filter layer 211 was formed into a desired pattern using a well-known photolithography technique employing a pigment dispersion resist solution in which was dispersed a green pigment. The blue filter conversion layer 212 was formed into a desired pattern using a well-known photolithography technique employing a pigment dispersion resist solution in which was dispersed a blue pigment.

Next, the red conversion filter layer 220 was formed into a desired pattern using a well-known photolithography technique employing a dispersed solution consisting of a substance that absorbed light having a wavelength of 550 nm or less and emitted light having a wavelength of 550 nm or more dissolved in a photosensitive acrylic polymer material or the like, which had an acrylic crosslinking functional group and had a high light transmittance in the visible light region.

The green conversion filter layer 221 was formed into a desired pattern using a well-known photolithography technique employing a dispersed solution consisting of a substance that absorbed light having a wavelength of 460 nm or less and emitted light having a wavelength of 460 nm or more dissolved in a photosensitive acrylic polymer material or the like, which had an acrylic crosslinking functional group and had a high light transmittance in the visible light region.

In the present Example, the red and green filters were constituted from two layers, a pigment dispersion color filter (210, 211) and the light-emitting substance-containing color conversion filter (220, 221).

The pattern formation method of the pigment dispersion color filter and the light-emitting substance-containing color conversion filter was the same as for Example 1 as illustrated in FIG. 1.

The white color organic EL emission splits by being transmitted through the red, green and blue filters, to thereby emit light in the three primary colors required for full color display. In such a case, by means of the red conversion filter layer 220, shorter wavelength light that is not usually transmitted was absorbed and light in the red color region was emitted, whereby the transmitted light of the red filter layer 210 was augmented with the emitted component, to thereby increase brightness. In addition, by means of the green conversion filter layer 221, shorter wavelength light that is not usually transmitted was absorbed and light in the green color region was emitted, whereby the transmitted light of the green filter layer 211 was augmented with the emitted component, to thereby increase brightness.

Furthermore, a porous insulation film which possessed the above-described characteristics (1) through (6) allowed brightness to be increased due to the facts that its refractive index was smaller than that of the opposing transparent substrate 202 and the light-scattering effects resulting from the nanopores that were present in the film were augmented, whereby the trapping of emissions, including the emissions from the organic EL layer transmitted through the red, green and blue filters and the emissions converted by the color conversion filters 220, 221 of the emissions from the organic EL layer, within the transparent substrate 202 was reduced for efficient coupling-out to the transparent substrate exterior.

### EXAMPLE 3

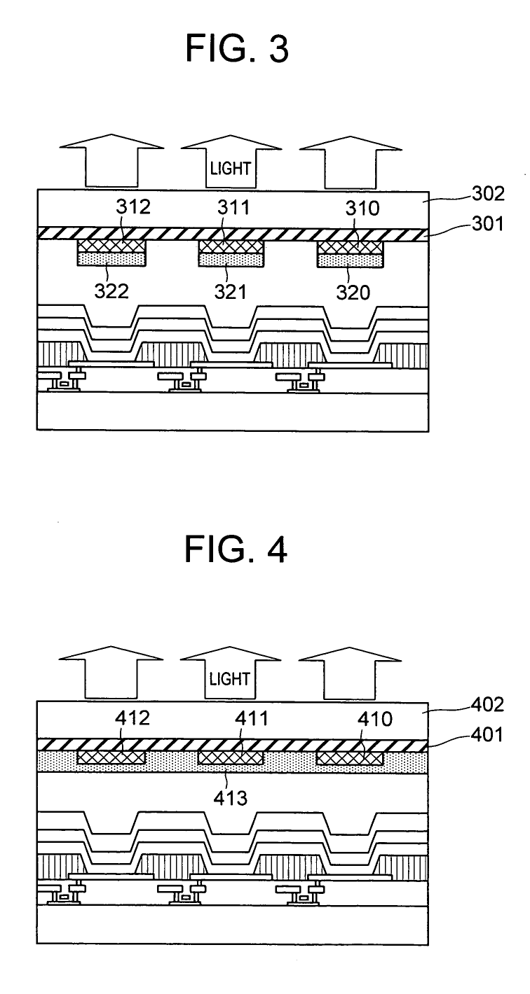

Next, as one example of the organic EL display apparatus according to the present invention, an organic EL display apparatus provided with a color conversion filter will be explained using the substrate cross-sectional view illustrated in FIG. 3.

Since the difference between FIG. 3 and Example 1 as illustrated in FIG. 1 lies in the structure of the opposing transparent substrate 302, this point will now be explained.

To achieve full color display by splitting the emissions from a white color organic EL layer, an opposing transparent substrate 302 was formed with red, green and blue pigment dispersion color filter patterns (310, 311, 312), and red, green and blue conversion filter patterns (320, 321, 322). Between these filter patterns and the opposing transparent substrate 302 was formed a porous insulation film 301.

In this case, the porous insulation film 301 was an insulation film which contained SiO and possessed the above-described characteristics (1) through (6). An insulation film which possesses these characteristics has good physical properties. The production method for this porous insulation film was the same as the production process explained for Example 1.

Next, the opposing transparent substrate 302-side red, green and blue pigment dispersion color filter patterns (310, 311, 312), and the red, green and blue conversion filter patterns (320, 321, 322) will be explained.

The red pigment dispersion color filter layer 310 was formed into a desired pattern using a well-known photolithography technique employing a pigment dispersion resist solution in which a red pigment was dispersed. The green pigment dispersion color filter layer 311 was formed into a desired pattern using a well-known photolithography technique employing a pigment dispersion resist solution in which was dispersed a green pigment. The blue pigment dispersion color filter layer 312 was formed into a desired pattern using a well-known photolithography technique employing a pigment dispersion resist solution in which was dispersed a blue pigment.

Next, the red conversion filter layer 320 was formed into a desired pattern using a well-known photolithography technique employing a dispersed solution consisting of a substance that absorbed light having a wavelength of 550 nm or less and emitted light having a wavelength of 550 nm or more dissolved in a photosensitive acrylic polymer material or the like, which had an acrylic crosslinking functional group and had a high light transmittance in the visible light region.

The green conversion filter layer 321 was also formed into a desired pattern using a well-known photolithography technique employing a dispersed solution consisting of a substance that absorbed light having a wavelength of 460 nm or less and emitted light having a wavelength of 460 nm or more dissolved in a photosensitive acrylic polymer material or the like, which had an acrylic crosslinking functional group and had a high light transmittance in the visible light region.

The blue conversion filter layer 322 was also formed into a desired pattern using a well-known photolithography technique employing a dispersed solution consisting of a substance that absorbed light having a wavelength of 420 nm or less and emitted light having a wavelength of 420 nm or more dissolved in a photosensitive acrylic polymer material or the like, which had a high light transmittance in the visible light region.

In the present Example, the red, green and blue filters were constituted from two layers, a pigment dispersion color filter (310, 311, 312) and a light-emitting substance-containing color conversion filter (320, 321, 322).

The pattern formation method of the pigment dispersion color filter and the light-emitting substance-containing color conversion filter was the same as for Example 1 as illustrated in FIG. 1.

The white color organic EL emission splits by being transmitted through the red, green and blue filters, to thereby emit light in the three primary colors required for full color display. In such a case, by means of the red conversion filter layer 320, shorter wavelength light that is not usually transmitted was absorbed and light in the red color region was emitted, whereby the transmitted light of the red filter layer 310 was augmented with the emitted component, to thereby increase brightness.

In addition, by means of the green conversion filter layer 321, shorter wavelength light that is not usually transmitted was absorbed and light in the green color region was emitted, whereby the transmitted light of the green filter layer 311 was augmented with the emitted component, to thereby increase brightness. By means of the blue conversion filter layer 322, shorter wavelength light that is not usually transmitted was absorbed and light in the green color region was emitted, whereby the transmitted light of the blue filter layer 312 was augmented with the emitted component, to thereby increase brightness.

Furthermore, a porous insulation film which possessed the above-described characteristics (1) through (6) allowed brightness to be increased due to the facts that its refractive index was smaller than that of the opposing transparent substrate 302 and the light-scattering effects resulting from the nanopores that were present in the film were augmented, whereby the trapping of emissions, including the emissions from the organic EL layer transmitted through the red, green and blue filters and the emissions converted by the color conversion filters of the emissions from the organic EL layer, within the transparent substrate 302 was reduced for efficient coupling-out to the transparent substrate exterior.

### EXAMPLE 4

Next, as one example of the organic EL display apparatus according to the present invention, an organic EL display apparatus provided with a color conversion filter will be explained using the substrate cross-sectional view illustrated in FIG. 4.

Since the difference between FIG. 4 and Example 1 as illustrated in FIG. 1 lies in the structure of the opposing transparent substrate 402 and in a blue conversion filter layer 413 being additionally provided, these points will now be explained.

To achieve full color display by splitting emissions from a white color organic EL layer, an opposing transparent substrate 402, in the same manner as in FIG. 1, was formed with a blue pigment dispersion color filter pattern (412), and red and green conversion filter patterns (410, 411). On top of these patterns, a blue conversion filter layer 413 was additionally formed. Between these filter patterns and the opposing transparent substrate 402 was formed a porous insulation film 401.

In this case, the porous insulation film was an insulation film which contained SiO and possessed the above-described characteristics (1) through (6). An insulation film which possesses these characteristics has good physical properties. The production method for this porous insulation film was the same as the production process explained for Example 1.

Next, the opposing transparent substrate 402-side blue pigment dispersion color filter pattern (412), the red and green conversion filter patterns (410, 411), and the blue conversion filter (413) will be explained. In this case, the blue pigment dispersion color filter pattern (412) and the red and green conversion filter patterns (410, 411) were formed in the same manner as Example 1 illustrated in FIG. 1.

The blue conversion filter layer 413 was deposited by coating over the red, green and blue filters using a dispersed solution consisting of a substance that absorbed light having a wavelength of 420 nm or less and emitted light having a wavelength of 420 nm or more dissolved in a photosensitive acrylic polymer material or the like, which had an acrylic crosslinking functional group and had a high light transmittance in the visible light region. The coating was then heated using a hot plate system and cured.

The white color organic EL emission splits by being transmitted through the red, green and blue filters, to thereby emit light in the three primary colors required for full color display. In such a case, in the blue conversion filter layer 413, shorter wavelength light was absorbed and light in the blue color region was emitted, whereby the transmitted light of the blue pigment dispersion color filter layer 412 was augmented with the emitted component, to thereby increase brightness.

Further, in the green conversion filter layer 411, due to the fact that the light-emitting substance absorbed the light having a wavelength of 460 nm or less to which the emissions of the blue color region in the blue conversion filter layer (413) is added, higher intensity light of a wavelength of 460 or more is emitted. This emitted component augmented the transmitted light, to thereby increase brightness.

In the red conversion filter layer 410, due to the fact that the light-emitting substance absorbed the light having a wavelength of 550 nm or less augmenting the emissions of the blue color region in the blue conversion filter layer 413, higher intensity light of a wavelength of 550 or more was emitted. This emitted component augmented the transmitted light, to thereby increase brightness.

Furthermore, the porous insulation film 401 which possessed the above-described characteristics (1) through (6) allowed brightness to be increased due to the facts that its refractive index was smaller than that of the transparent substrate of the conversion filter substrate and the light-scattering effects resulting from the nanopores that were present in the film were augmented, whereby the trapping of emissions, including the emissions from the organic EL layer transmitted through the conversion filter layers and the emissions augmented by the conversion filter layers from such emissions, within the transparent substrate was reduced for efficient coupling-out to the transparent substrate exterior.

### EXAMPLE 5

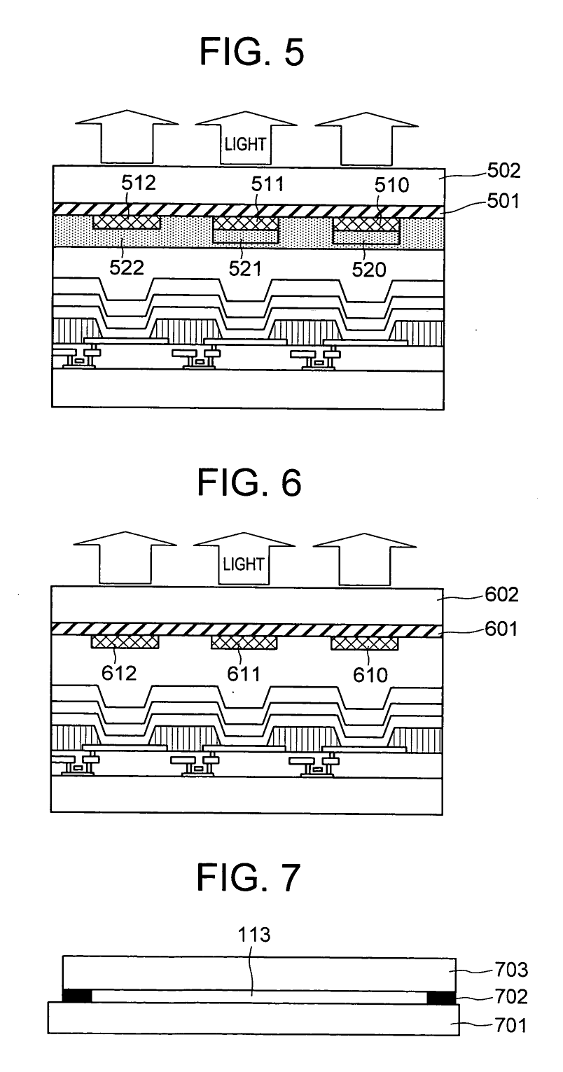

Next, as one example of the organic EL display apparatus according to the present invention, an organic EL display apparatus provided with a color conversion filter will be explained using the substrate cross-sectional view illustrated in FIG. 5.

Since the difference between FIG. 5 and Example 1 as illustrated in FIG. 1 lies in the structure of the opposing transparent substrate 502, and the difference with Example 2 as illustrated in FIG. 2 lies in the fact that a blue conversion filter layer 522 was additionally provided, these points will be explained.

To achieve full color display by splitting emissions from a white color organic EL layer, an opposing transparent substrate 502 was formed with red, green and blue pigment dispersion color filter patterns (510, 511, 512), red and green conversion filter patterns (520, 521), and a blue conversion filter (522). Between these patterns and blue conversion filter, and the substrate was formed a porous insulation film 501.

In this case, the porous insulation film 501 was an insulation film which contained SiO and possessed the above-described characteristics (1) through (6). An insulation film which possesses these characteristics has good physical properties. The production method for this porous insulation film was the same as the production process explained in FIG. 1.

Next, the opposing transparent substrate 502-side red, green and blue pigment dispersion color filter patterns (510, 511, 512), the red and green conversion filter patterns (520, 521), and the blue conversion filter (522) will be explained.

The red, green and blue pigment dispersion color filter patterns (510, 511, 512) and the red and green conversion filter patterns (520, 521) were formed in the same manner as Example 2 illustrated in FIG. 2.

The blue conversion filter layer 522 was deposited by coating so as to cover the red, green and blue filters using a dispersed solution consisting of a substance that absorbed light having a wavelength of 420 nm or less and emitted light having a wavelength of 420 nm or more dissolved in a photosensitive acrylic polymer material or the like, which had an acrylic crosslinking functional group and had a high light transmittance in the visible light region. The coating was then heated using a hot plate system and cured.

The emissions from the white color organic EL splits by being transmitted through the red, green and blue filters, to thereby emit light in the three primary colors required for full color display. In such a case, in the blue conversion filter layer 522, shorter wavelength light was absorbed and light in the blue color region was emitted, whereby the transmitted light of the blue pigment dispersion color filter pattern 512 was augmented with the emitted component, to thereby increase brightness.

Further, in the red conversion filter layer 520, due to the fact that the light-emitting substance absorbed the light having a wavelength of 550 nm or less augmenting the emissions of the blue color region in the blue conversion filter layer 522, higher intensity light of a wavelength of 550 or more was emitted. This emitted component augmented the transmitted light of the red pigment dispersion color filter layer 510, to thereby increase brightness.

In the green conversion filter layer 521, due to the fact that the light-emitting substance absorbed the light having a wavelength of 460 nm or less augmenting the emissions of the blue color region in the blue conversion filter layer 522, higher intensity light of a wavelength of 460 or more was emitted. This emitted component augmented the transmitted light of the green pigment dispersion color filter layer 511, to thereby increase brightness.

Furthermore, a porous insulation film 501 which possessed the above-described characteristics (1) through (6) allowed brightness to be increased due to the facts that its refractive index was smaller than that of the transparent substrate of the conversion filter substrate and the light-scattering effects resulting from the nanopores that were present in the film were augmented, whereby the trapping of emissions, including the emissions from the organic EL layer transmitted through the color filters and the emissions converted by the conversion filters of the emissions from the organic EL layer, within the transparent substrate 502 was reduced for efficient coupling-out to the transparent substrate exterior.

### EXAMPLE 6

Next, as one example of the organic EL display apparatus according to the present invention, an organic EL display apparatus provided with a color conversion filter will be explained using the substrate cross-sectional view illustrated in FIG. 6.

Since the difference between FIG. 6 and Example 1 as illustrated in FIG. 1 lies in the structure of the opposing transparent substrate 602, and especially in the structure of the blue conversion filter layer 612, this point will be explained.

To achieve full color display by splitting emissions from a white color organic EL layer, an opposing transparent substrate 602 was formed with red, green and blue conversion filter patterns (610, 611, 612), wherein between these filter patterns and the substrate 602 was formed a porous insulation film 601.

In this case, the porous insulation film 601 was an insulation film which contained SiO and possessed the above-described characteristics (1) through (6). An insulation film which possesses these characteristics has good physical properties. The production method for this porous insulation film was the same as the production process explained for Example 1.

Next, the opposing transparent substrate 602-side red, green and blue conversion filter patterns (610, 611, 612) will be explained.

The red and green conversion filter patterns (610, 611) were formed in the same manner as Example 1 illustrated in FIG. 1.

The blue conversion filter layer (612) was formed into a desired pattern using a well-known photolithography technique by mixing a solution of a substance that absorbed light having a wavelength of 420 nm or less and emitted light having a wavelength of 420 nm or more into a pigment dispersion resist solution in which was dispersed a blue pigment.

This pattern was formed by coating the above-described solution onto the porous insulation film 601 of a glass substrate 602 and preheating using a hot plate system to thereby form a coating film. Next, using a well-known photolithography technique, the coating film was exposed and developed to form a desired pattern. Subsequently, after using a hot plate system, the obtained desired pattern was heated and cured.

The emissions from the white color organic EL splits by being transmitted through the red, green and blue filters, to thereby emit light in the three primary colors required for full color display. In such a case, in the blue conversion filter layer 612, shorter wavelength light was absorbed and light in the blue color region was emitted, whereby the transmitted light was augmented with the emitted component, to thereby increase brightness.

Further, in the red conversion filter layer 610, a light-emitting substance absorbed light having a wavelength of 550 nm or less and emitted light having a wavelength of 550 nm or more, whereby this emitted component augmented the transmitted light, to thereby increase the red color region brightness.

In the green conversion filter layer 611, a light-emitting substance absorbed light having a wavelength of 460 nm or less and emitted light having a wavelength of 460 nm or more, whereby this emitted component augmented the transmitted light, to thereby increase the green color region brightness.

Furthermore, the porous insulation film 601 which possessed the above-described characteristics (1) through (6) allowed brightness to be increased due to the facts that its refractive index was smaller than that of the transparent substrate serving as the conversion filter substrate and the light-scattering effects resulting from the nanopores that were present in the film were augmented, whereby the trapping of emissions, including the emissions from the organic EL layer transmitted through the conversion filters and the emissions converted by the conversion filters of the emissions from the organic EL layer, within the transparent substrate 602 was reduced for efficient coupling-out to the transparent substrate exterior.

Ultimately, as illustrated in the cross-section of FIG. 7, the organic EL display apparatus was sealed in a high-purity dry nitrogen atmosphere in which the humidity had been reduced to an ultralow level, using a sealant 702 between both the substrates of the TFT circuit/white color organic EL layer formed substrate 701 and the color conversion filter transparent substrate 703, to thereby form a structure sealed with dry nitrogen gas in the sealed space 113.

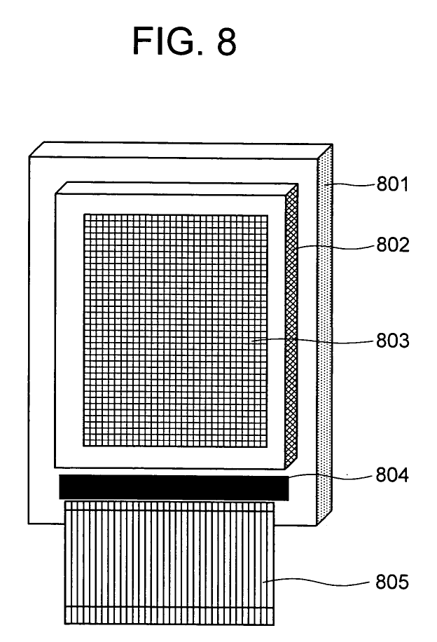

In FIG. 8, a display apparatus which has a display region 803 above a color conversion filter transparent substrate 802 is completed by mounting a driver IC804 for driving a TFT onto a TFT circuit/white color organic EL layer formed substrate 801 using a chip-on-glass mounting method, and connecting this to a flexible printed wiring board 805 for connecting to a peripheral circuit mounted with an LSI for control, power supply or the like.

In the structure sealed using a sealant between both the substrates of the TFT circuit/white color organic EL layer formed substrate and the color conversion filter transparent substrate, if the porous insulation film formed on the color conversion filter transparent substrate side possesses the above-described characteristic (7), a porous insulation film which is exposed to the sealed space exhibits a drying efficiency which adsorbs moisture that is present between the sealed substrates. The emission life of organic EL display apparatuses is known to deteriorate due to moisture, so that a conventionally sealed organic EL display apparatus is required to have a desiccant. However, because of this moisture adsorbing function, the desiccant can be omitted, and thus there exists the advantages of a reduction in parts costs and in the step of adding the desiccant.

### EXAMPLE 7

An organic EL display apparatus having the cross-section shown in FIG. 1 was prepared under the following conditions.

In FIG. 1, a non-alkali glass (model number 1737 glass substrate) manufactured by Corning Incorporated was used as the substrate 101. The refractive index of this glass was approximately 1.52.

Onto the glass substrate 101, a TFT element circuit layer 102 formed with a thin-film transistor and electrode wiring was formed by a commonly-known deposition technique using a sputtering method or a CVD method and a patterning technique using a photolithography method.

Using the same techniques, an aluminum film serving as the electrode 103 sandwiching an organic EL layer 105 was formed in a thickness of 80 nm, and a silicon nitride film serving as the separating insulation film 104 was formed in a thickness of 50 nm, whereby an active-matrix organic EL display apparatus was separated by pixel units.

A white color organic EL layer 105 was formed over the entire surface of this electrode 103 and separating insulation film 104. As the organic EL layer 105, an electron injection layer, an electron transport layer, a hole block layer and a hole transport layer were successively formed on the aluminum electrode 103 in that order, and a 70 nm-thick IZO film was vacuum deposited as a transparent electrode 106 over the entire surface thereof. Above this, a 150 nm-thick silicon nitride film as an inorganic insulation film 107 was successively deposited having gas barrier properties which did not transmit moisture or oxygen.

As the electron injection layer, LiF was vacuum deposited. The substrate temperature was at room temperature, the degree of vacuum was 10⁻⁴ Pa and the heating of the boat was controlled so that the deposition rate was from 0.1 to 1 nm/s. The film thickness was 0.5 nm.

As the electron transport layer, Alq3 (tris(8-quinolinol)-aluminum complex was vacuum deposited. The substrate temperature was at room temperature, the degree of vacuum was 10⁻⁴ Pa and the heating of the boat was controlled so that the deposition rate was from 0.1 to 1 nm/s. The film thickness was 50 nm.

As the hole block layer, p-EtTAZ (3-(4-Biphenyl)-4-(ethylphenyl)-5-(4-tert-butylphenyl)-1,2,4-triazole) was vacuum deposited. The substrate temperature was at room temperature, the degree of vacuum was 10⁻⁴ Pa and the heating of the boat was controlled so that the deposition rate was from 0.1 to 1 nm/s. The film thickness was 3 nm.

As the hole transport layer, TPD (N,N-(3-methylphenyl)-1,1′-diphenyl-4,4′-diamine) was vacuum deposited. The substrate temperature was at room temperature, the degree of vacuum was 10⁻⁴ Pa and the heating of the boat was controlled so that the deposition rate was from 0.1 to 1 nm/s. The film thickness was 40 nm.

In FIG. 1, the above-described non-alkali glass substrate manufactured by Corning Incorporated was used as the opposing transparent substrate 109. As the porous insulation film 108, a methyl isobutyl ketone coating solution having a hydrogen silsesquioxane compound as a main constituent was coated onto the substrate, then heated using a hot plate heating system in a nitrogen atmosphere for 10 minutes at 100° C., 10 minutes at 150° C., 10 minutes at 230° C., and then 10 minutes at 350° C., to thereby form a porous insulation film 108 which had SiO as a main constituent and which possessed the following characteristics.

Film thickness: 230 nm; Density: 1.12 g/cm³; Refractive index: 1.29; Film hardness: 0.61 GPa; Film elasticity modulus: 9.17 GPa; Average pore diameter in the film: 1.4 nm; Maximum pore diameter in the film: 0.6 nm; Visible light region light transmittance: 90% or more

Next, the red, green and blue filter patterns (110, 111, 112) of the opposing transparent substrate 109 will be explained.

For the red filter layer 110, a solution was prepared by mixing 0.5 wt % of the light-emitting substance DCM (4-dicyanmethylene-2-methyl-6-(p-dimethylaminostyryl)-4H-pyran) into a pigment dispersion type photosensitive resist solution in which a red pigment was dispersed. This solution was coated onto the porous insulation film 108, then formed into a coating film by heating in a nitrogen atmosphere for 4 minutes at 80° C. using a hot plate system.

Next, using a well-known photolithography technique, the coating film was exposed and developed to form a desired pattern. Subsequently, using a hot plate system, the obtained desired pattern was heated and cured for 15 minutes at 150° C. in an inert nitrogen atmosphere, to thereby form a 1.8 μm-thick pattern.

For the green filter layer 111, a solution was prepared by mixing 0.5 wt % of the light-emitting substance Coumarin 30 into a pigment dispersion type photosensitive resist solution in which a green pigment was dispersed. This solution was subjected to the same forming technique as that for the above-described red filter to form a 1.8 μm-thick pattern.

For the blue filter conversion layer 112, a 1.8 μm-thick pattern was formed using the same forming technique as that for the above-described red filter by employing a pigment dispersion type photosensitive resist solution in which a blue pigment was dispersed.

Next, in a high-purity dry nitrogen atmosphere, a sealant was used to seal the TFT circuit/white color organic EL layer formed substrate 101 and the color conversion filter transparent substrate 109 in a state wherein dry nitrogen was encapsulated in the sealed space 113. A driver IC was mounted, and connected to flexible printed wiring board for connecting to a peripheral circuit, to thereby prepare the organic EL display apparatus as illustrated in FIGS. 7 and 8.

### COMPARATIVE EXAMPLE 1

A red filter having a 1.8 μm-thick pattern was formed using the same formation method as that in Example 1, except that in place of the red and green filters of Example 1, a pigment dispersion type photosensitive resist solution in which a red pigment was dispersed was used. A green filter having a 1.8 μm-thick pattern was formed in the same manner using a pigment dispersion type photosensitive resist solution in which a green pigment was dispersed.

Except for the red and green filters, an organic EL display apparatus was prepared under the same conditions as those of Example 1. Power was conducted into the organic EL display apparatuses of Example 1 and Comparative Example 1 under the same conditions, wherein emissions from the white color organic EL that coupled-out to the transparent side were split by transmitting through red, green and blue filters, to thereby emit light in the three primary colors required for full color display. The spectral intensities were compared against the visible light wavelength region.

The emission spectral intensities were measured using a device combining a photonic multichannel spectral analyzer (Hamamatsu Photonics C5967) and a polycrometer (Hamamatsu Photonics C5094) manufactured by Hamamatsu Photonics KK.

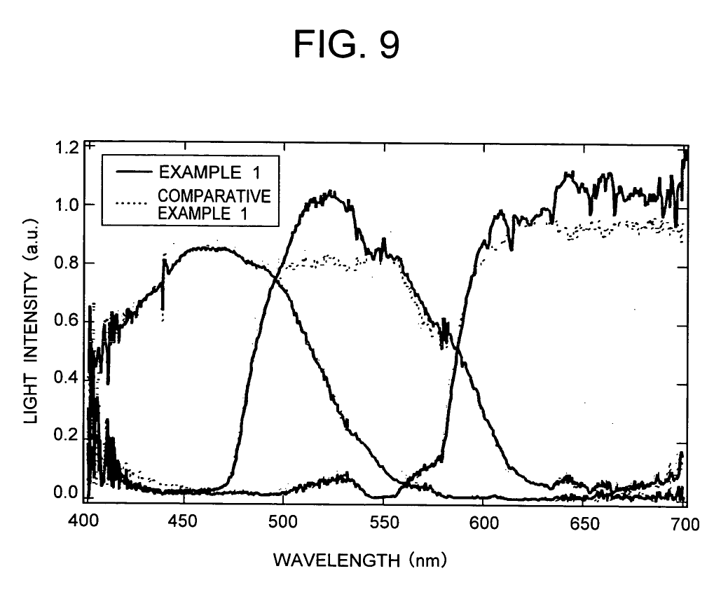

FIG. 9 illustrates the spectrum of the emission transmitted through the red, green and blue filters. From this, it was clear that the emission spectrum measured from the organic EL display apparatus according to Example 1 had a greater intensity than that of Comparative Example 1, wherein using integration a result was obtained showing an intensity approximately 10% higher in the green emission region and the red emission region.

In the present example, the red and green filters were color conversion filters which contained a color pigment and a light-emitting substance. Emissions from the white color organic EL were split by transmitting through red, green and blue filters, to thereby emit light in the three primary colors required for full color display.

In such a case, by means of the color conversion filters, in the green filter layer, shorter wavelength light that is not usually transmitted was absorbed and light in the green color region was emitted, whereby the transmitted light of the green filter layer was augmented with the emitted component, to thereby increase brightness. Further, in the red filter layer, shorter wavelength light that is not usually transmitted was absorbed and light in the red color region was emitted, whereby the transmitted light of the red filter layer was augmented with the emitted component, to thereby increase brightness.

Furthermore, by using a porous insulation film according to the present invention, the refractive index was smaller than that for a transparent substrate serving as a conversion filter substrate, and by incorporating the light-scattering effects resulting from the nanopores that were present in the film, the trapping of emissions, including the emissions from the organic EL layer transmitted through the conversion filters and the emissions converted by the conversion filters of the emissions from the organic EL layer, within the transparent substrate was reduced for efficient coupling-out to the transparent substrate exterior, to thereby improve brightness.

### COMPARATIVE EXAMPLE 2

In place of the porous insulation layer 108 in Example 1, a CVD-deposited silicon nitride film having as a raw material tetraethylsilane (commonly referred to as a TEOS film), which is a well-known silicon nitride that does not have any pores in the film, was formed into a film possessing the characteristics of a thickness of 230 nm, a density of 2.23 g/cm³, and a refractive index of 1.46.

Except for this film, an organic EL display apparatus was prepared under the same conditions as those of Example 1. Power was conducted in the organic EL display apparatuses of Example 1 and Comparative Example 2 under the same conditions, wherein emissions from the white color organic EL that coupled-out to the transparent side were split by transmitting through red, green and blue filters, to thereby emit light in the three primary colors required for full color display. The spectral intensities were compared against the visible light wavelength region.

The emission spectrum measured from the organic EL display apparatus according to Example 1 had a greater intensity than that of Comparative Example 2, wherein using integration a result was obtained showing an intensity approximately 10% higher in the green emission region and the red emission region.

As explained above, by using a porous insulation film according to the present invention, the refractive index was smaller than that for a transparent substrate serving as a conversion filter substrate, and by incorporating the light-scattering effects resulting from the nanopores that were present in the film, the trapping of emissions, including the emissions from the organic EL layer transmitted through the conversion filters and the emissions converted by the conversion filters of the emissions from the organic EL layer, within the transparent substrate can be reduced for efficient coupling-out to the transparent substrate exterior, to thereby improve brightness.

### EXAMPLE 8

An organic EL display apparatus having the cross-section shown in FIG. 2 was prepared under the following conditions. Except for the opposing transparent substrate 202 side, the apparatus was formed under the same conditions as those of Example 1.

In FIG. 2, a non-alkali glass substrate was used as the opposing transparent substrate 202. As the porous insulation film 201, in contrast to Example 1, a methyl isobutyl ketone coating solution having a hydrogen silsesquioxane compound as a main constituent was coated onto the substrate, then heated using a hot plate heating system in a nitrogen atmosphere for 10 minutes at 100° C., 10 minutes at 150° C., 10 minutes at 200° C., and then 20 minutes at 350° C., to thereby form a porous insulation film 201 which had SiO as a main constituent and which possessed the following characteristics.

Film thickness: 230 nm; Density: 1.25 g/cm³; Refractive index: 1.30; Film hardness: 4.6 GPa; Film elasticity modulus: 3.2 GPa; Average pore diameter in the film: 2.3 nm; Visible light region light transmittance: 90% or more

Next, the red, green and blue pigment dispersion color filter patterns (210, 211, 212) of the opposing transparent substrate 201 side, and the red and green conversion filter patterns (220, 221) will be explained.

For the red pigment dispersion color filter pattern 210, a 1.8 μm-thick pattern was formed using the same forming technique as that for Example 1 by employing a pigment dispersion type photosensitive resist solution in which a red pigment was dispersed.

For the green pigment dispersion color filter pattern 211, a 1.8 μm-thick pattern was formed using the same forming technique as that for Example 1 by employing a pigment dispersion type photosensitive resist solution in which a green pigment was dispersed.

The blue pigment dispersion color filter pattern 212 was formed under the same conditions as those of Example 1.

For the red conversion filter 220, a solution was prepared by mixing 0.5 wt % of DCM into a solution of a photosensitive acrylic polymer material having an acrylic crosslinking functional group and a high light transmittance in the visible light region, to thereby form a 1 μm-thick pattern using the same technique as that for Example 1.

For the green filter layer 221, a solution was prepared by mixing 0.5 wt % of Coumarin 30 into a solution of a photosensitive acrylic polymer material having an acrylic crosslinking functional group and a high light transmittance in the visible light region, to thereby form a 1 μm-thick pattern using the same technique as that for Example 1.

The emission spectrum measured from the organic EL display apparatus according to the present Example had using integration an intensity of respectively 20% higher than that of Comparative Example 1 in the green emission region and the red emission region.

In the present example, the red and green filters were constituted from two layers, a pigment dispersion color filter layer and a light-emitting substance-containing color conversion filter layer. In such a case, emissions from the white color organic EL were split by transmitting through the red, green and blue filters, to thereby emit light in the three primary colors required for full color display.

In such a case, by means of the color conversion filters, in the green filter layer, shorter wavelength light that is not usually transmitted was absorbed and light in the green color region was emitted, whereby the transmitted light of the green filter layer was augmented with the emitted component, to thereby increase brightness. Further, in the red filter layer, shorter wavelength light that is not usually transmitted was absorbed and light in the red color region was emitted, whereby the transmitted light of the red filter layer was augmented with the emitted component, to thereby increase brightness.

Furthermore, by using the porous insulation film according to the present invention, the refractive index was smaller than that for a transparent substrate serving as a conversion filter substrate, and by incorporating the light-scattering effects resulting from the nanopores that were present in the film, the trapping of emissions, including the emissions from the organic EL layer transmitted through the conversion filters and the emissions converted by the conversion filters of the emissions from the organic layer, within the transparent substrate was reduced for efficient coupling-out to the transparent substrate exterior, to thereby improve brightness.

### EXAMPLE 9

An organic EL display apparatus having the cross-section shown in FIG. 3 was prepared under the following conditions. Except for the opposing transparent substrate 302 side, the apparatus was formed under the same conditions as those of Example 1.

In FIG. 3, a non-alkali glass substrate was used as the opposing transparent substrate 302. As the porous insulation film 301, in contrast to Example 1, a methyl isobutyl ketone coating solution having a hydrogen silsesquioxane compound as a main constituent was coated onto the substrate, then heated using a hot plate heating system in a nitrogen atmosphere for 10 minutes at 100° C., 10 minutes at 150° C., and 10 minutes at 220° C., and then heated in a furnace for 30 minutes at 350° C., to thereby form a porous insulation film 301 which had SiO as a main constituent and which possessed the following characteristics.

Film thickness: 230 nm; Density: 1.42 g/cm³; Refractive index: 1.33; Film hardness: 0.53 GPa; Film elasticity modulus: 6.7 GPa; Average pore diameter in the film: 1.1 nm; Maximum pore diameter in the film: 0.64 nm; Visible light region light transmittance: 90% or more

Next, the red, green and blue pigment dispersion color filter patterns (310, 311, 312) of the opposing transparent substrate 302 side, and the red, green and blue conversion filter patterns (320, 321, 322) will be explained.

For the red pigment dispersion color filter 310, a pigment dispersion type photosensitive resist solution in which a red pigment was dispersed was coated onto the porous insulation film 301, then formed into a coating film by heating in an inert nitrogen atmosphere for 4 minutes at 80° C. using a hot plate system. Next, using a well-known photolithography technique, the coating film was exposed and developed to form a desired pattern. Subsequently, using a hot plate system, the obtained desired pattern was heated and cured for 15 minutes at 200° C. in a nitrogen atmosphere, to thereby form a 1.8 μm-thick pattern.

For the green pigment dispersion color filter 311, a 1.8 μm-thick pattern was formed using the same technique and conditions as for the above-described red pigment dispersion color filter 310 by employing a pigment dispersion type photosensitive resist solution in which a green pigment was dispersed.

For the blue pigment dispersion color filter 312, a 1.8 μm-thick pattern was formed using the same technique and conditions as for the above-described red pigment dispersion color filter 310 by employing a pigment dispersion type photosensitive resist solution in which a blue pigment was dispersed.

For the red conversion filter 320, a solution was prepared by mixing 1 wt % of DCM into a solution of a photosensitive acrylic polymer material having an acrylic crosslinking functional group and a high light transmittance in the visible light region, which solution was then coated, then formed into a coating film by heating in a nitrogen atmosphere for 4 minutes at 80° C. using a hot plate system.

Next, using a well-known photolithography technique, the coating film was exposed and developed to form a desired pattern. Subsequently, using a hot plate system, the obtained desired pattern was heated and cured for 15 minutes at 150° C. in an inert nitrogen atmosphere, to thereby form a 1 μm-thick pattern.

For the green conversion filter 321, a solution was prepared by mixing 1 wt % of Coumarin 30 into a solution of a photosensitive acrylic polymer material having an acrylic crosslinking functional group, to thereby form a 1 μm-thick pattern using the same technique and conditions as for the above-described red conversion filter 320.

For the blue filter conversion 322, a solution was prepared by mixing 1 wt % of Coumarin 4 into a into a solution of a photosensitive acrylic polymer material having an acrylic crosslinking functional group, to thereby form a 1 μm-thick pattern using the same technique and conditions as for the above-described red conversion filter 320.

The emission spectrum measured from the organic EL display apparatus according to the present Example had using integration an intensity of respectively 20% higher than that of Comparative Example 1 in the green emission region and the red emission region. In addition, a 9% increase in intensity was achieved in the blue emission region.

In the present example, the red and green filters were constituted from two layers, a pigment dispersion color filter and a light-emitting substance-containing color conversion filter layer. In such a case, emissions from the white color organic EL were split by transmitting through the red, green and blue filters, to thereby emit light in the three primary colors required for full color display.

In such a case, by means of the color conversion filters, in the green filter layer, shorter wavelength light that is not usually transmitted was absorbed and light in the green color region was emitted, whereby the transmitted light of the green filter layer was augmented with the emitted component, to thereby increase brightness. Further, in the red filter layer, shorter wavelength light that is not usually transmitted was absorbed and light in the red color region was emitted, whereby the transmitted light of the red filter layer was augmented with the emitted component, to thereby increase brightness. In the blue filter conversion layer, light, having a wavelength of 420 nm or less was absorbed and light having a wavelength of 420 nm or higher was emitted, whereby the transmitted light of the blue filter layer was augmented with the emitted component, to thereby increase brightness.

Furthermore, by using the porous insulation film according to the present invention, the refractive index was smaller than that for a transparent substrate serving as a conversion filter substrate, and by incorporating the light-scattering effects resulting from the nanopores that were present in the film, the trapping of emissions, including the emissions from the organic EL layer transmitted through the conversion filters and the emissions converted by the conversion filters of the emissions from the organic layer, within the transparent substrate was reduced for efficient coupling-out to the transparent substrate exterior, to thereby improve brightness.

### EXAMPLE 10

An organic EL display apparatus having the cross-section shown in FIG. 4 was prepared under the following conditions. Except for the opposing transparent substrate 402 side, the apparatus was formed under the same conditions as those of Example 1.

In FIG. 4, a non-alkali glass substrate was used as the opposing transparent substrate 402. As the porous insulation film 401, in contrast to Example 1, a methyl isobutyl ketone coating solution having a hydrogen silsesquioxane compound as a main constituent was coated onto the substrate, then heated using a hot plate heating system in a nitrogen atmosphere for 10 minutes at 100° C., 10 minutes at 150° C., and 10 minutes at 200° C., and subsequently heated for 30 minutes in a nitrogen atmosphere at 350° C. using a furnace heating system, to thereby form a porous insulation film which had SiO as a main constituent and which possessed the following characteristics.

Film thickness: 250 nm; Density: 1.12 g/cm³; Refractive index: 1.29; Film hardness: 0.61 GPa; Film elasticity modulus: 9.17 GPa; Average pore diameter in the film: 1.4 nm; Maximum pore diameter in the film: 0.6 nm; Visible light region light transmittance: 90% or more

Next, the blue pigment dispersion color filter pattern (412) of the opposing transparent substrate 402 side, red, green and blue conversion filter patterns (410, 411), and the blue conversion filter (413) will be explained.

For the red conversion filter layer 410, a solution was prepared by mixing 5 wt % of the light-emitting substance DCM into a pigment dispersion type photosensitive resist solution in which a red pigment was dispersed. This solution was coated onto the porous insulation film, then formed into a coating film by heating in a nitrogen atmosphere for 4 minutes at 80° C. using a hot plate system.

Next, using a well-known photolithography technique, the coating film was exposed and developed to form a desired pattern. Subsequently, using a hot plate system, the obtained desired pattern was heated and cured for 15 minutes at 150° C. in an inert nitrogen atmosphere, to thereby form a 1.8 μm-thick pattern.

For the green pigment dispersion color filter layer 411, a solution was prepared by mixing 5 wt % of the light-emitting substance Coumarin 535 into a pigment dispersion type photosensitive resist solution in which a green pigment was dispersed, to thereby form a 1.8 μm-thick pattern using the same technique and conditions as for the above-described red conversion filter 410.

For the blue pigment dispersion color filter layer 412, a pigment dispersion type photosensitive resist solution in which a blue pigment was dispersed was coated onto the porous insulation film, to thereby form a coating film by heating in an inert nitrogen atmosphere for 4 minutes at 80° C. using a hot plate system. Next, using a well-known photolithography technique, the coating film was exposed and developed to form a desired pattern. Subsequently, using a hot plate system, the obtained desired pattern was heated and cured for 15 minutes at 200° C. in a nitrogen atmosphere, to thereby form a 1.8 μm-thick pattern.

For the blue conversion filter layer 413, a solution was prepared by mixing 5 wt % of Coumarin 4 into a into a solution of an acrylic polymer material having an acrylic crosslinking functional group, whereby a 1 μm-thick pattern was formed using the same technique and conditions as for the above-described red conversion filter 410.

The emission spectrum measured from the organic EL display apparatus according to the present Example had using integration an intensity of respectively 20% higher than that of Comparative Example 1 in the green emission region and the red emission region. In addition, an about 9% increase in intensity was achieved in the blue emission region.

In the present example, the red and green filters were constituted from two layers, a color conversion filter layer, which contained a color pigment and a light-emitting substance, and the blue conversion filter layer. In addition, the blue filter was constituted from two layers, a pigment dispersion color filter layer and a light-emitting substance-containing color conversion filter layer.

Emissions from the white color organic EL were split by transmitting through the red, green and blue filters, to thereby emit light in the three primary colors required for full color display. In such a case, in the blue conversion filter layer 413, light having a wavelength of 420 nm or less was absorbed and light having a wavelength of 420 nm or higher was emitted, whereby the transmitted light of the blue pigment dispersion color filter layer 412 was augmented with the emitted component, to thereby increase brightness.

In the green filter layer 411, due to the fact that the light-emitting substance absorbed light having a wavelength of 460 nm or less augmenting the emissions of the blue color region in the blue conversion filter layer 413, higher intensity light of a wavelength higher than 460 nm was emitted, whereby the transmitted light was augmented with such emitted component, to thereby increase brightness.

In the red filter layer 410, due to the fact that the light-emitting substance absorbed light having a wavelength of 550 or less augmenting the emissions of the blue color region in the blue conversion filter layer 413, higher intensity light of a wavelength higher than 550 nm was emitted, whereby the transmitted light was augmented with such emitted component, to thereby increase brightness of the red color region.

Furthermore, a porous insulation film which possessed the above-described characteristics (1) through (6) allowed brightness to be increased due to the facts that its refractive index was smaller than that of the opposing transparent substrate and the light-scattering effects resulting from the nanopores that were present in the film were augmented, whereby the trapping of emissions, including emissions from the organic EL layer transmitted through the conversion filters and the emissions converted by the color conversion filters of the emissions from the organic EL layer, within the transparent substrate was reduced for efficient coupling-out to the transparent substrate exterior.

### EXAMPLE 11

An organic EL display apparatus having the cross-section shown in FIG. 5 was prepared under the following conditions. Except for the opposing transparent substrate 502 side, the apparatus was formed under the same conditions as those of Example 1.

In FIG. 5, a non-alkali glass substrate was used as the opposing transparent substrate 502. As the porous insulation film 501, in contrast to Example 1, a methyl isobutyl ketone coating solution having a hydrogen silsesquioxane compound as a main constituent was coated onto the substrate, then heated using a furnace heating system in a nitrogen atmosphere for 20 minutes at 100° C., 20 minutes at 150° C., 20 minutes at 230° C., and 30 minutes at 350° C., to thereby form a porous insulation film 501 which had SiO as a main constituent and which possessed the following characteristics. Film thickness: 200 nm; Density: 1.00 g/cm³; Refractive index: 1.29; Film hardness: 0.27 GPa; Film elasticity modulus: 3.33 GPa; Average pore diameter in the film: 1.3 nm; Maximum pore diameter in the film: 0.55 nm; Visible light region light transmittance: 90% or more

Next, the red, green and blue pigment dispersion color filter patterns (510, 511, 512), the red and green conversion filter patterns (520, 521), and the blue conversion filter pattern (522) will be explained.

For the red pigment dispersion color filter layer 510, a pigment dispersion type photosensitive resist solution in which a red pigment was dispersed was coated onto the porous insulation film, whereby a coating film was formed by heating in a nitrogen atmosphere for 4 minutes at 80° C. using a hot plate system.

Next, using a well-known photolithography technique, the coating film was exposed and developed to form a desired pattern. Subsequently, using a hot plate system, the obtained desired pattern was heated and cured for 15 minutes at 200° C. in an inert nitrogen atmosphere, to thereby form a 1.8 μm-thick pattern.

For the green pigment dispersion color filter layer 511, a 1.8 μm-thick pattern was formed using the same technique and conditions as for the above-described red pigment dispersion color filter layer 510 by employing a pigment dispersion type photosensitive resist solution in which a green pigment was dispersed.

For the blue pigment dispersion color filter layer 512, a 1.8 μm-thick pattern was formed using the same technique and conditions as for the above-described red pigment dispersion color filter layer 510 by employing a pigment dispersion type photosensitive resist solution in which a blue pigment was dispersed.

For the green conversion filter layer 521, a solution was prepared by mixing 5 wt % of Coumarin 535 into a solution of an acrylic polymer material having an acrylic crosslinking functional group, whereby a 1 μm-thick pattern was formed using the same technique and conditions as for the above-described red pigment dispersion color filter layer 510.

For the red conversion filter layer 520, a solution was prepared by mixing 5 wt % of DCM a into a solution of an acrylic polymer material having an acrylic crosslinking functional group, whereby a 1 μm-thick pattern was formed using the same technique and conditions as for the above-described red pigment dispersion color filter layer 510.

For the blue conversion filter layer 522, a solution was prepared by mixing 5 wt % of Coumarin 4 into a solution of an acrylic polymer material having an acrylic crosslinking functional group, whereby a 1 μm-thick pattern was formed using the same technique and conditions as for the above-described red pigment dispersion color filter layer 510.

The emission spectrum measured from the organic EL display apparatus according to the present Example had using integration an intensity of respectively 30% higher than that of Comparative Example 1 in the green emission region and the red emission region. In addition, an about 9% increase in intensity was achieved in the blue emission region.

In the present example, the red filter was constituted from three layers, consisting of the red pigment dispersion color filter layer, the light-emitting substance-containing color conversion filter layer, and the blue conversion filter layer. The green filter was also constituted from three layers, consisting of the green pigment dispersion color filter layer, the light-emitting substance-containing color conversion filter layer, and the blue conversion filter layer. The blue filter was constituted from two layers, consisting of the blue pigment dispersion color filter layer and the light-emitting substance-containing color conversion filter layer.

Emissions from the white color organic EL were split by transmitting through the red, green and blue filters, to thereby emit light in the three primary colors required for full color display. In such a case, in the blue filter conversion layer 522, light having a wavelength of 420 nm or less was absorbed and light having a wavelength of 420 nm or higher was emitted, whereby the transmitted light of the blue pigment dispersion color filter layer 512 was augmented with the emitted component, to thereby increase brightness. In the green conversion filter layer 521, due to the fact that the light-emitting substance absorbed light having a wavelength of 460 nm or less augmenting the emissions of the blue color region in the blue conversion filter layer 522, higher intensity light of a wavelength higher than 460 nm was emitted, whereby the transmitted light was augmented with such emitted component, to thereby increase brightness of the green color region.

In the red filter layer 520, due to the fact that the light-emitting substance absorbed light having a wavelength of 550 nm or less augmenting the emissions of the blue color region in the blue conversion filter layer 522, higher intensity light of a wavelength higher than 550 nm was emitted, whereby the transmitted light was augmented with such emitted component, to thereby increase brightness of the red color region.

Furthermore, a porous insulation film which possessed the above-described characteristics (1) through (6) allowed brightness to be increased due to the facts that its refractive index was smaller than that of the opposing transparent substrate and the light-scattering effects resulting from the nanopores that were present in the film were augmented, whereby the trapping of emissions, including the emissions from the organic EL layer transmitted through the color conversion filters and the emissions converted by the color conversion filters of the emissions from the organic EL layer, within the transparent substrate was reduced for efficient coupling-out to the transparent substrate exterior.

### EXAMPLE 12

An organic EL display apparatus having the cross-section shown in FIG. 6 was prepared under the following conditions. Except for the opposing transparent substrate 602 side, the apparatus was formed under the same conditions as those of Example 1.

In FIG. 6, a non-alkali glass substrate was used as the opposing transparent substrate 602. As the porous insulation film 601, in contrast to Example 1, a methyl isobutyl ketone coating solution having a hydrogen silsesquioxane compound as a main constituent was coated onto the substrate, then heated using a furnace heating system in a nitrogen atmosphere for 20 minutes at 100° C., 20 minutes at 150° C., 20 minutes at 200° C., and 60 minutes at 350° C., to thereby form a porous insulation film 601 which had SiO as a main constituent and which possessed the following characteristics.

Film thickness: 200 nm; Density: 1.12 g/cm³; Refractive index: 1.29; Film hardness: 0.61 GPa; Film elasticity modulus: 9.17 GPa; Average pore diameter in the film: 1.4 nm; Maximum pore diameter in the film: 0.6 nm; Visible light region light transmittance: 90% or more

Next, the red, green and blue conversion filter patterns (610, 611, 612) of the opposing transparent substrate 602 side will be explained.

For the green conversion filter layer 611, a solution was prepared by mixing 5 wt % of the light-emitting substance Fluorol 555 into a solution of a pigment dispersion type photosensitive resist solution in which a green pigment was dispersed. This solution was coated onto the porous insulation film, then formed into a coating film by heating in an inert nitrogen atmosphere for 4 minutes at 80° C. using a hot plate system. Next, using a well-known photolithography technique, the coating film was exposed and developed to form a desired pattern. Subsequently, using a hot plate system, the obtained desired pattern was heated and cured for 15 minutes at 150° C. in an inert nitrogen atmosphere, to thereby form a 1.8 μm-thick pattern.

For the red conversion filter layer 610, a solution was prepared by mixing 5 wt % of the light-emitting substance DCM into a solution of a pigment dispersion type photosensitive resist solution in which a red pigment was dispersed, whereby a 1.8 μm-thick pattern was formed using the same technique and conditions as for the above-described green color conversion layer 611.

For the blue conversion filter layer 612, a solution was prepared by mixing 5 wt % of the light-emitting substance Coumarin 4 into a solution of a pigment dispersion type photosensitive resist solution in which a blue pigment was dispersed, whereby a 1.8 μm-thick pattern was formed using the same technique and conditions as for the above-described green color conversion layer 611.

The emission spectrum measured from the organic EL display apparatus according to the present Example had using integration an intensity of respectively 10% higher than that of Comparative Example 1 in the green emission region and the red emission region. In addition, a 5% increase in intensity was achieved in the blue emission region.

In the present example, the red, green and blue filters were constituted from a color conversion filter layer which contained a color pigment and a light-emitting substance.

Emissions from the white color organic EL were scattered by transmitting through the red, green and blue filters, to thereby emit light in the three primary colors required for full color display. In such a case, in the blue filter conversion layer 612, light having a wavelength of 420 nm or less was absorbed and light having a wavelength of 420 nm or higher was emitted, whereby the transmitted light of the blue filter was augmented with the emitted component, to thereby increase brightness. In the green conversion filter layer 611, a light-emitting substance absorbed light having a wavelength of 460 nm or less and emitted light having a wavelength of 460 nm or higher, whereby the transmitted light was augmented with the emitted component, to thereby increase the green color region brightness.

In the red conversion filter layer 610, a light-emitting substance absorbed light having a wavelength of 550 nm or less and emitted light having a wavelength of 550 nm or higher, whereby the transmitted light was augmented with the emitted component, to thereby increase the red color region brightness.

Furthermore, the porous insulation film which possessed the above-described characteristics (1) through (6) allowed brightness to be increased due to the facts that its refractive index was smaller than that of the opposing transparent substrate and the light-scattering effects resulting from the nanopores that were present in the film were augmented, whereby the trapping of emissions, including the emissions from the organic EL layer transmitted through the color conversion filters and the emissions converted by the color conversion filters of the emissions from the organic EL layer, within the transparent substrate was reduced for efficient coupling-out to the transparent substrate exterior.

### EXAMPLE 13

An organic EL display apparatus having the cross-section shown in FIG. 1 was prepared under the following conditions. Except for the porous insulation film 108 of the opposing transparent substrate 109 side, the apparatus was formed under the same conditions as those of Example 1.

As the porous insulation film 108, in contrast to Example 1, a methyl isobutyl ketone coating solution having a hydrogen silsesquioxane compound as a main constituent was coated onto the substrate, then heated using a hot plate heating system in a nitrogen atmosphere or similar an inert atmosphere for 10 minutes at 100° C., 10 minutes at 150° C., 10 minutes at 230° C., and 10 minutes at 350° C., to thereby form a porous insulation film 108 which had SiO as a main constituent and which possessed the following characteristics.

Film thickness: 200 nm; Density: 1.12 g/cm³; Refractive index: 1.29; Film hardness: 0.61 GPa; Film elasticity modulus: 9.17 GPa; Visible light region light transmittance: 90% or more

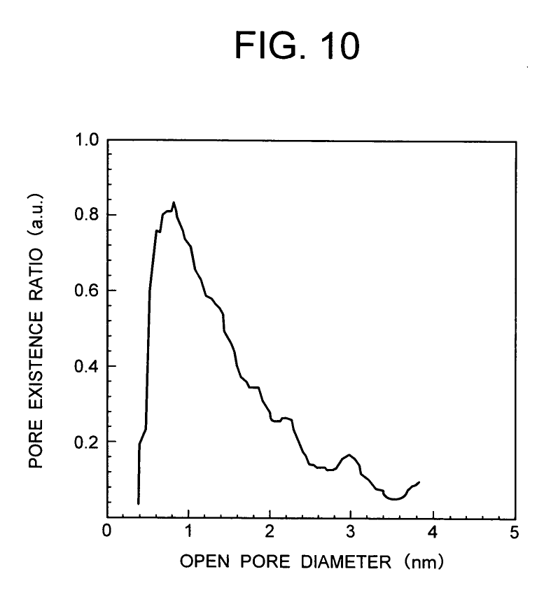

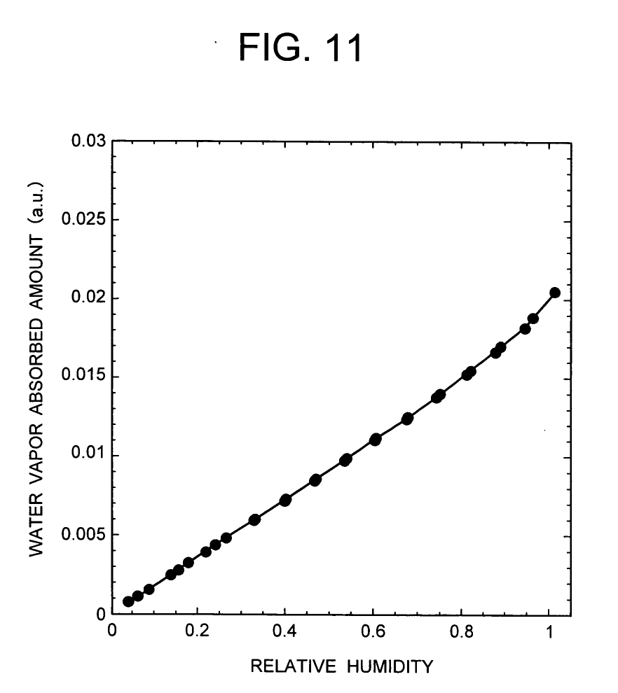

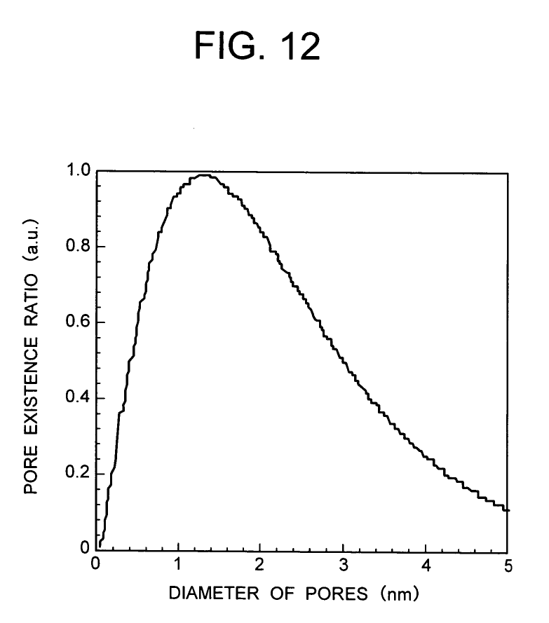

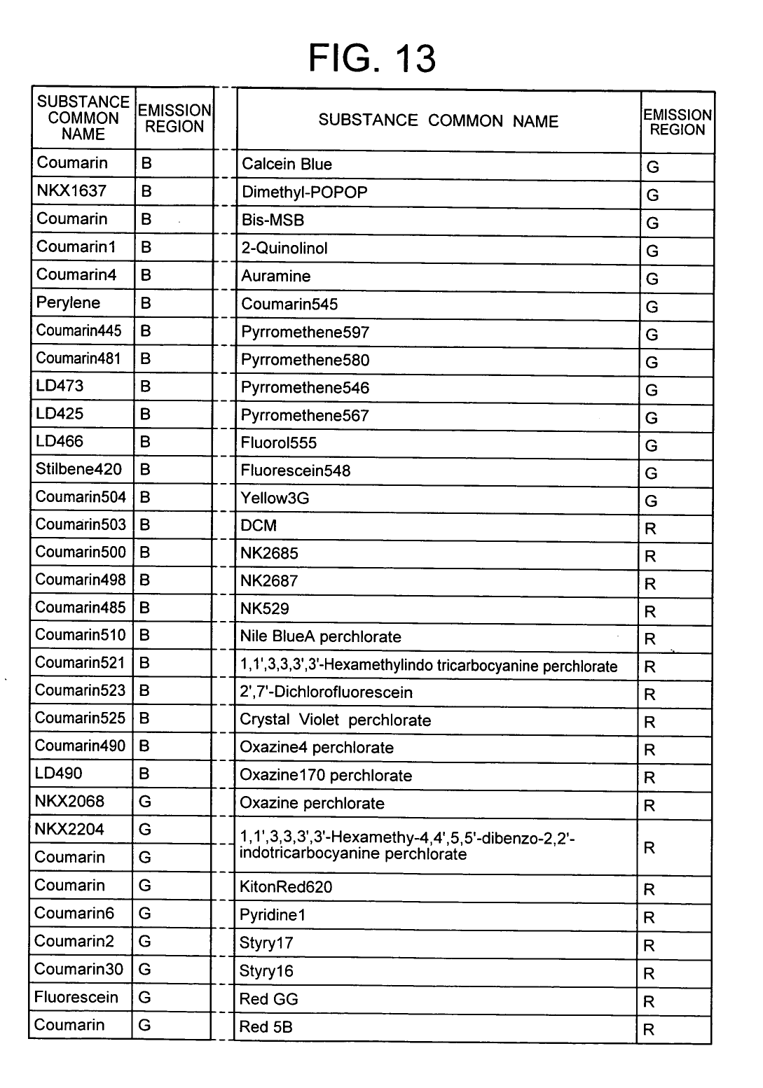

In addition, the porous insulation film 108 according to the present Example possessed open nanopores in the film surface. The open pore diameters had the distribution shown in FIG. 10, wherein pores were present with an open diameter from 0.5 nm to 3.5 nm with a maximum diameter of 0.8 nm. This porous insulation film 108, due to the fact that the open nanopores such as those present in the film surface adsorb moisture, possessed the characteristic that the absorbed water vapor amount increased according to the humidity in the sealed organic EL display apparatus, as is illustrated in FIG. 11.

The emission spectrum measured from the organic EL display apparatus according to the present Example had using integration an intensity of respectively 10% higher than that of Comparative Example 1 in the green emission region and the red emission region.

In the present example, the red and green filters were color conversion filters which contained a color pigment and a light-emitting substance. Emissions from the white color organic EL were scattered by transmitting through the red, green and blue filters, to thereby emit light in the three primary colors required for full color display. In such a case, by means of the color conversion filters, in the green filter layer 111, by absorbing shorter wavelength light that is not usually transmitted and emitting light in the green color region, the transmitted light of the green filter was augmented with the emitted component, to thereby increase brightness. In the red filter layer 110, by absorbing shorter wavelength light that is not usually transmitted and emitting light in the red color region, the transmitted light of the red filter was augmented with the emitted component, to thereby increase brightness.

In addition to the above-described characteristics (1) through (6), due to the fact that the porous insulation film according to the present example possessed the moisture adsorption characteristic illustrated in the above-described characteristic (7), the porous insulation film, which was exposed to the sealed space, exhibited a drying efficiency for adsorbing moisture that was present between the sealed substrates. The emission life of organic EL display apparatuses is known to deteriorate due to moisture, so that a conventionally sealed organic EL display apparatus is required to have a desiccant. However, because of this moisture adsorbing function, the desiccant can be omitted, and thus there exists the advantages of a reduction in parts costs and in the step of adding the desiccant.

### COMPARATIVE EXAMPLE 3

For the above-described Comparative Example 2, evaluation of the moisture adsorbing characteristic was carried out on the TEOS film deposited in place of the porous insulation film using the same method as that for Example 13. However, since open pores are not present on the film surface in a TEOS film, in contrast to the porous insulation film used in Example 13, no moisture adsorption was found.

From this, it was learned that by possessing a moisture adsorbing characteristic such as that illustrated by the porous insulation film according to the present invention in Example 13, a porous insulation film, which is exposed to a sealed space, exhibits a drying efficiency for adsorbing moisture that is present between the sealed substrates. The emission life of organic EL display apparatuses is known to deteriorate due to moisture, so that a conventionally sealed organic EL display apparatus is required to have a desiccant. However, because of this moisture adsorbing function, the desiccant can be omitted, and thus there exists the advantages of a reduction in parts costs and in the step of adding the desiccant.

It should be further understood by those skilled in the art that although the foregoing description has been made on embodiments of the invention, the invention is not limited thereto and various changes and modifications may be made without departing from the spirit of the invention and the scope of the appended claims.

1. An organic electroluminescence display apparatus formed by stacking a substrate which comprises a light emitting device having an organic electroluminescence layer formed between electrode layers, and a transparent substrate which comprises a color conversion filter on a surface opposing the substrate, wherein the transparent substrate which comprises a color conversion filter comprises a light-transmissive porous insulation film having nanopores, and the color conversion filter on the porous insulation film.

2. The organic electroluminescence display apparatus according to claim 1 which is an active-matrix display apparatus driven by a thin-film transistor circuit connected to one of the electrode layers.

3. The organic electroluminescence display apparatus according to claim 1 which is covered with an inorganic insulation film having gas barrier properties over the whole of an uppermost surface on which the light emitting device is formed.

4. The organic electroluminescence display apparatus according to claim 1, wherein the color conversion filter comprises a substance for emitting light in a visible light region in a pigment dispersion color filter.

5. The organic electroluminescence display apparatus according to claim 1, wherein the color conversion filter comprises a pigment dispersion color filter layer and a color conversion filter layer which comprises a substance for emitting light in a visible light region.

6. The organic electroluminescence display apparatus according to claim 4, wherein one of the color conversion filters is a green filter which comprises a substance for absorbing light having a wavelength of 460 nm or less and emitting light having a wavelength of 460 nm or more.

7. The organic electroluminescence display apparatus according to claim 5, wherein one of the color conversion filter layers is a green conversion filter layer which comprises a substance for absorbing light having a wavelength of 460 nm or less and emitting light having a wavelength of 460 nm or more.

8. The organic electroluminescence display apparatus according to claim 4, wherein one of the color conversion filters is a red filter which comprises a substance for absorbing light having a wavelength of 550 nm or less and emitting light having a wavelength of 550 nm or more.

9. The organic electroluminescence display apparatus according to claim 5, wherein one of the color conversion filter layers is a red conversion filter layer which comprises a substance for absorbing light having a wavelength of 550 nm or less and emitting light having a wavelength of 550 nm or more.

10. The organic electroluminescence display apparatus according to claim 4, wherein one of the color conversion filters is a blue filter which comprises a substance for absorbing light having a wavelength of 420 nm or less and emitting light having a wavelength of 420 nm or more.

11. The organic electroluminescence display apparatus according to claim 5, wherein one of the color conversion filter layers is a blue filter which comprises a substance for absorbing light having a wavelength of 420 nm or less and emitting light having a wavelength of 420 nm or more.

12. The organic electroluminescence display apparatus according to claim 1, wherein the color conversion filter comprises:
a blue filter comprising a blue pigment dispersion color filter layer;
a green conversion filter which consists of two layers, a green pigment dispersion color filter layer and a color conversion filter layer comprising a substance for absorbing light having a wavelength of 460 nm or less and emitting light having a wavelength of 460 nm or more, or a mixed layer of these two layers;
a red conversion filter which consists of two layers, a red pigment dispersion color filter layer and a color conversion filter layer comprising a substance for absorbing light having a wavelength of 550 nm or less and emitting light having a wavelength of 550 nm or more, or a mixed layer of these two layers; and
a blue conversion filter covering the entire surface of these filters, which comprises a substance for absorbing light having a wavelength of 420 nm or less and emitting light having a wavelength of 420 nm or more.

13. The organic electroluminescence display apparatus according to claim 1, wherein the porous insulation film comprises SiO.

14. The organic electroluminescence display apparatus according to claim 1, wherein the porous insulation film has a film density of 0.6 g/cm³ to less than 1.8 g/cm³, and a film refractive index lower than that of the transparent substrate.

15. The organic electroluminescence display apparatus according to claim 1, wherein the porous insulation film comprises a main nanopore constituent having a pore diameter of 0.2 nm to 5.0 nm.

16. The organic electroluminescence display apparatus according to claim 1, wherein the porous insulation film has an average nanopore diameter of 0.6 nm to 3.0 nm.

17. The organic electroluminescence display apparatus according to claim 1, wherein the porous insulation film has a maximum nanopore diameter of 0.4 nm to 2.0 nm.

18. The organic electroluminescence display apparatus according to claim 1, wherein the porous insulation film has a visible light wavelength region with a transmittance of 80% or more.

19. The organic electroluminescence display apparatus according to claim 1, wherein the porous insulation film is an SiO-containing insulation film obtained by heating a coating film having a hydrogen silsesquioxane compound or a methyl silsesquioxane compound as a main constituent.

20. The organic electroluminescence display apparatus according to claim 19, wherein the porous insulation film is an SiO-containing insulation film obtained by heating a coating film having a hydrogen silsesquioxane compound or a methyl silsesquioxane compound as a main constituent at 300° C. to 450° C.

21. The organic electroluminescence display apparatus according to claim 1, wherein the porous insulation film is an SiO-containing insulation film formed by a chemical vapor deposition reaction using a source gas having an alkylsilane compound or an alkoxysilane compound as a main constituent.

22. The organic electroluminescence display apparatus according to claim 21, wherein the porous insulation film is an SiO-containing insulation film obtained by forming a film by a chemical vapor deposition reaction using a source gas having an alkylsilane compound or an alkoxysilne compound as a main constituent, then heating the film at 300° C. to 450°.

23. The organic electroluminescence display apparatus according to claim 1, wherein the porous insulation film has pores open to the film surface, the open pores possessing a characteristic of adsorbing moisture.

24. An organic electroluminescence display apparatus formed by stacking a substrate which comprises a light emitting device having an organic electroluminescence layer formed between electrode layers, and a transparent substrate which comprises a color conversion filter on a surface opposing the substrate, and sealing the substrate periphery, wherein the transparent substrate which comprises a color conversion filter comprises an SiO-containing porous insulation film which is a porous substance having nanopores, and wherein the porous insulation film has open pores on the film surface, and thereby possesses a drying function for adsorbing moisture in the sealed substrates.
